(19) United States
(12) Patent Application Publication
(10) Pub. No.: US 2006/0149687 A1
(43) Pub. Date: Jul. 6, 2006

(54) System and method for automated management of custom home design and build projects

(75) Inventor: Robert Vernon McLemore, Charlotte, NC (US)

Correspondence Address: OSTROLENK FABER GERB & SOFFEN, 1180 AVENUE OF THE AMERICAS, NEW YORK, NY, 100368403, US

(73) Assignee: HouseRaising, Inc.

(21) Appl. No.: 11/029,569

(22) Filed: Jan. 5, 2005

(51) Int. Cl. G06F 17/00

(52) U.S. Cl. 705/400

(57) ABSTRACT

The present invention preferably enables parties to electronically submit parameters into an Internet application regarding a custom homebuilding project. The application accurately predicts labor and materials costs associated therefor. The present invention also provides details directed to the processes associated with custom homebuilding projects and eliminates surprises that may arise during a building process.

### FIELD OF THE INVENTION

The present invention relates to a system and method for managing a workforce, and, more particularly, for providing automated management of parties and processes associated with custom home designs, budgeting and building.

### BACKGROUND OF THE INVENTION

Complexities associated with negotiating and managing custom home designs and building projects are numerous, in large part due to many different professionals who are needed to design and construct the custom home. For example, homebuyers, builders, designers, sub-contractors, materials suppliers, financial representatives and attorneys interact to provide services during custom homebuilding. Usually, these and other parties operate independently, providing services that are unique to the respective industries represented by the parties. The fact is there is no central management of the parties associated in the custom home design and build project, yet the homebuilder is usually found legally responsible for the actions of these individuals.

Unfortunately, improper management, miscommunication and misunderstanding frequently results in conflict that drives up costs and frustration for many of the associated parties. The inability to predict and control processes associated with custom homebuilding forces large and small builders alike to lose money on custom home projects. The inability for the custom homebuilder to manage or predict results in custom homebuilding is why that segment of the homebuilding industry experiences one of the highest failure rates of all industries in the United States.

One frequent complaint made by custom homebuyers is related to mismanagement of time. For example, a plumber is scheduled to provide plumbing services during week #8, and an installer of sheet rock is scheduled for week #9. If the plumber doesn't meet the week #8 schedule, the sheet rock installer is delayed and may not be available again for weeks after week #9. Such time delays frequently occur when a builder loses control of subcontractors and is unsuccessful in holding them to strict schedules. It is not uncommon for a building job, for example, plumbing, to stretch from two weeks to complete to two months.

During a typical custom home design and build process, a homebuyer usually works with an architect to prepare plans and specifications. The homebuyer then meets with homebuilders to obtain a building process (or a home plan) for the home. Assuming the home plan is affordable, the homebuyers sign a binding contract with a builder.

Builders are usually classified as either “large” or “small,” depending upon the number of new construction projects they undertake, and the number of parties they manage. Both large and small custom homebuilders have positive and negative qualities.

Large homebuilding companies may be able to construct a custom designed home for a lower price than a small homebuilder. Large builders typically have access to volume discounts on materials and supplies, and can pass the savings on to the homebuyer. Moreover, large homebuilders typically have access to a large labor force of subcontractors enabling large builders to shop around for lower rates, force subcontractors to compete, thereby driving down the cost of labor and materials. Even in the case of a large builder, dealing with custom features detailed in unique plans works against pricing advantages by the large builders.

After finalizing the contract with a custom homebuyer, a large builder typically turns control of the building process to a supervisor or foreman with whom the buyer has had no previous experience. Unlike a speculative home whereby the builder acts as owner and builder, in a custom and potentially pre-sold home project, the homebuyer monitors the home and the builder is required to satisfy the needs of the owner. For large custom homebuilders particularly, absenteeism of the parties that negotiated the deal with the owners-leaving the oversight of the project to a party that was not initially involved, results in mistakes made by subcontractors. For example, locations of electrical outlets and water faucets, incorrect window locations, location and details of cabinets and fixtures, incorrect paint shades and improper lot grading are mistakes typically complained of by buyers of custom homes.

Small custom homebuilders purportedly offer more personal contact with the homebuyer. Unfortunately, while their creative and personal skills may provide more attention to details and may be somewhat superior to that of superintendents employed by the large custom homebuilders, small custom homebuilders typically do not have control over the projects. If the builder is not in control, problems develop and costs increase, making the small homebuilders more vulnerable to financial failures. Moreover and due to their size, small builders do not have access to volume discounts on many supplies that materials suppliers give to large builders, making the business of providing value more difficult.

A custom homebuyer typically begins the buying process with a dream of a new home. When the architect begins designing the house with the homebuyer, the homebuyer's budget in not usually the driving force at that stage of the custom process. Designers are paid to design the home, usually more interested in creating a unique home design and not as concerned about the costs of building the home. The homebuyers do not know the true costs of the home they designed until they meet with the builders. For example, the costs of plans and specifications invested in designing the unique home is not usually tied to the costs of building the home.

Homebuyers meet with builders that are forced to locate ways of reducing costs of the home design. The process becomes a function of limiting specifications and choices. For example, a homebuyer may be able to afford a home that is 3,500 square feet, but can only afford a vinyl exterior rather than, for example, stone or brick. Once the builder and the buyer decide upon the particulars of the custom home, a contract is signed that binds the parties to the construction of the new home. Often homebuyers are forced to have several home plans designed before settling on a plan that they can afford.

After construction of a custom home begins, issues often arise which frequently prevent the builder from completing the project within the estimated budget. For example, architectural plans do not conform to standard material sizes, resulting in material waste and excessive costs. Moreover, unexpected increases of the cost of materials, supplies, and other ancillary expenses during the course of a project results in the inability of the builder to keep the project within the estimated budget.

One way that builders try to maintain an estimated budget throughout the custom homebuilding process is to artificially inflate the cost of the project during the initial development of the project. Rather than absorbing costs that can't be foreseen, the builder increases the entire budget by an arbitrary amount, for example, 15% of the total cost of the project.

A frequent conflict occurring in the prior art between homebuilders and homebuyers regards management of capital. Typically, either funds are drawn for services not yet completed, or funds are held until the party in control of the funds decides to release them. In either case, conflict arises because services are either not performed or capital is not provided for services that have been performed.

Another common conflict occurring in the prior regards one or more tasks that require completion, even though the new construction may be suitable for occupancy or the homebuyer has taken physical possession. For example, fixtures may require adjustments, room colors may be incorrectly painted, incorrect trim may be applied or other mistakes or problems that are not resolved during construction remain outstanding. It is not uncommon for homebuyers to withhold funds from builders because of lingering issues with respect to completion of the new home. Frequently, the buyer uses funds unfairly as leverage against builders to force completion of various tasks that may not, typically, be required, such as touch-up items. Withheld funds turn into more and more tasks being added to a punch list. Moreover, the amount of money that the buyer withholds as leverage may far exceed the value of services and materials that are required for completion. The buyer may believe that such leverage will force the homebuilder to complete the tasks. Unfortunately, builders are unable to pay the final bills due on a home project, thus liens appear which add financial problems for homebuyers and builders. Frequently builders and buyers will end relations on a sour note, with the builder refusing to complete certain tasks, and buyers not enjoying the final completion of their custom home.

In the prior art, custom homebuyers desiring to design and build custom homes are faced with multitudes of challenges. Those challenges range from the necessity of working with architects on design and specification selections, to selecting the right builder to act as the general contractor on the project.

Although they believe they are in control of the process, custom homebuyers are required to pay architects to begin the design process, and further deal one-on-one with the designers and decorators. Often, due to building costs that are unknown while the plans are developed, and, further, due to plan modifications dictated by site requirements, design changes must be made in the plans and specifications before homebuyers and builder can settle on a firm price.

As a result of last minute changes in plans and specifications, most design and build projects begin with homebuilders and homebuyers working from incomplete plans and specifications.

Once plans and specifications are complete, homebuyers continue the process, including selecting the builder who becomes the general contractor for the project. In these custom designed home projects, the right builder appears to be the small builder that is ready, willing and able to build the home at what appears to be a fair price. It is important to the homebuyer that the right builder is capable of providing the required attention to custom home details. In the prior art, homebuyers enter into contracts with these small builders who are expected to build the home within a set period of time and at a pre-set price. To meet the terms of the contract, the builder must locate and develop sub contractor relationships and obtain price quotes from approximately fifty-eight vendors in order to complete the average custom home project. Most of the time, builders commit to these custom home projects at “turn-key” prices that are negotiated many months before construction of the home actually begun.

Further in the prior art, sub-contractors and vendors available to small homebuilders are not parties to the new home contracts. These vendors usually make adjustments to the prices in the months when fees are charged to builders, and are seldom willing to quote fixed prices months in advance. Because the vendor is outside of the contract, it is unlikely the small homebuilder can obtain price protection on these projects, thus, the cost of the project often increases, resulting in financial disasters for the builders. Moreover, history shows that when the small builder experiences financial trouble during a project, one way or another, the homebuyers share in that financial loss.

As evidenced by both homebuyers and homebuilders alike who speak out about being unhappy with the results of prior art custom home design and build processes, the fixed price process is flawed. The prior art process is flawed because the responsible party in the project (i.e., the small builder) cannot reasonably predict the outcome of the projects that have been contracted with homebuyers. Homebuyers and homebuilders continue to develop fixed price contracts on home projects that cannot be predicted. The inability to predict costs for these projects forces a high percentage of the projects into conflict. When the prior art process fails, the results are liens, lawsuits and financial nightmares for homebuyers and builders alike.

Homebuyers, hoping to reduce the price of the custom home design and build project, take added financial risks by entering into “costs-plus” contracts. In a “costs plus” contract, the builder is contractually not responsible for costs overruns. These contracts are entered into with builders when homebuyers believe that the cost of custom home project can be predicted. The homebuyer that enters into a “cost-plus” contract faces most of the same challenges as described above, and faces the disadvantage of “cost-plus” builders having little to no incentive to invest time and energy to keep costs down. These “cost-plus” contracts usually result in the homebuyer paying a higher price for the custom home than expected, and further results in financial problems for the homebuyer.

Moreover, during the last decade, custom homebuyers have been offered computerized homebuilding management programs whereby individuals acquire software that reportedly prepares them to manage the building of their own homes. The marketing scheme presented in these homebuilding programs is that homebuyers can use the software to eliminate builder profits from their projects. Though it is believed some of software applications result in savings for some, overwhelmingly, these “build your own home” programs fail to meet the needs of most homebuyers. In fact, the homebuyers that are most attracted to costs savings from these build your own home programs are typically the individuals that can least afford the financial risks. Thus, the fallacy that homebuyers experience in choosing build it yourself software programs stems from unpredictable costs described above. Further, in such build your own home scenarios, vendors realize that the project is a one time effort, and thus have little to no incentive to be competitive, both in price and scheduling. The homebuyer typically spends a large part of their reported cost savings in overcharges from unrelated vendors.

Further and in the prior art, state-approved and state-administered tests and financial requirements for becoming a licensed homebuilder typically fail to prepare individuals to operate successful homebuilding businesses. Though state administered tests may cover basic design and estimating skills sufficient to direct the bidding custom homes process, the testing and code techniques fall far short of preparing the builder to manage pre-sold homebuilding projects. The building code and other homebuilding manuals available may help prepare individuals for bidding on a home to be constructed, but they do not adequately address the economics of operating a business based on pricing a product six to eight months before its can be created. The building code may explain how the state can use existing homebuilding laws to restrict a builder's day-to-day activities, but it falls short of exposing the individual to operating a business in an uncontrolled environment. Most builders commit to manage custom home projects over which they have no control. Issuing homebuilding licenses to unqualified individuals is a flaw in the design/build industry. As a result, homebuilder failure rates are extremely high when compared to other businesses. Individuals obtain homebuilder licenses that allow them to open and operate businesses even though they are simply not prepared to build custom designed homes.

In the prior art, custom homebuyers seeking to fulfill a dream of owning a custom designed home enter into contracts with false expectations. From being required to invest in plans without knowing the cost of building the home, to selecting the right builder, custom homebuyers are not adequately prepared to undertake the process of designing and building their own home. For example, most custom homebuyers order house plans from magazines before lots are selected and invest in custom design modifications without knowledge of the actual cost to build the custom design.

Since, in the prior art, relationships are not forged between substantially all of the parties associated with a custom homebuilding project, conflict is frequently caused by lack of control by any party and results in unforeseen costs Thus, the process continues in a stare of inability for the builder to accurately project the outcome or costs of a custom home. In the prior art, the parties are forced to assume opposing or competing positions, and the building process is usually turned into an inter-party tug of war. In large part, this is due to the fact that no single party has control over the entire new homebuilding project.

Computer hardware and software applications have been developed to assist both custom homebuilders and buyers during custom homebuilding. These automated solutions, however, do not offer an integrated, on-line package that is used by all of the parties to new home construction.

The custom homebuilding industry has failed to meet the needs of the principals, i.e., homebuyers, homebuilders and vendors.

### SUMMARY OF THE INVENTION

The present invention preferably enables parties to electronically submit parameters into an Internet-based software application regarding a custom homebuilding project. The application accurately lists specifications and design details that are sufficient to predict labor and materials costs for the project prior to investing in home plans as associated therefor. The present invention also provides specific details directed to the processes associated with custom home design and build projects and eliminates surprises that may arise during a building process. Further, the designs provided by the present invention preferably ensure that materials are ordered according to an economy of scale.

Further, the present invention provides a method for predicting the cost of labor and materials for a custom building construction, such that the actual cost of labor and materials after completing the construction project is the same as the predicted cost of the construction project.

The present invention further provides a method for using a user terminal coupled to a site processor across a communication network to manage new constructions by selecting from a database electronic standard construction information including characteristics related to at least one of total square footage, garage size, number of rooms, number of bathrooms, location of rooms, and price. A user selects from the database electronic modification information including characteristics related to at least one of construction features and the invention uses an algorithm that applies the electronic modification information to the electronic standard construction information to generate electronic modified construction information. Thereafter, an algorithm is used that retrieves from the database electronic labor information including characteristics related to at least one of builders, sub-contractors, vendors, materials suppliers, time estimates, and cost estimates related to at least one materials and labor.

The present invention comprises databases that include information regarding new, in-process and completed projects. By providing substantially real-time and on-line access, the databases are regularly updated with current information. For example, users electronically provide design and price parameters that allow accurate predictions of labor costs, sub-contract and vendor costs such that the users can foresee the total costs of custom homes prior to the homes' construction.

### BRIEF DESCRIPTION OF THE DRAWINGS

For the purposes of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows a sample hardware arrangement constructed in accordance with the present invention;

FIG. 2 is a block diagram of the functional elements of a network connecting device used in accordance with the present invention;

FIG. 3 illustrates parties and devices constructed in accordance with the present invention;

FIG. 4A shows a triangle structure representing a homebuyer, homebuilder and vendor;

FIG. 4B shows a triangle structure representing a regional president, a regional operations officer, and a regional financial officer;

FIG. 4C shows a triangle structure representing national and regional officers in accordance with the present invention;

FIG. 5A is a sample Internet web page providing a plurality of standard home designs available for selection in accordance with the present invention;

FIG. 5B illustrates a sample Internet web home page provided to users of the present invention;

FIG. 6 is a flow chart identifying three processes associated with selling a custom home in accordance with the present invention;

FIG. 7 is a flow chart providing more details with respect to the process of selling a custom home;

FIGS. 8A and 8B illustrate a sample approved project startup form in accordance with the present invention;

FIG. 9 shows a builder project start notification form for notifying builders of a pending new homebuilding project;

FIGS. 10A and 10B show a sample project checklist form used during the building of a custom home;

FIG. 11 shows a post contract plan upgrade form for modifying terms to an existing sales contract;

FIGS. 12A and 12B illustrate a final project budget, cash flow and profit used for analyzing a completed custom built home;

FIGS. 12C and 12D illustrate a builder partner project progress checklist for monitoring completion of tasks in accordance with the present invention;

FIG. 13 is an example pre-closing inspection form for identifying unresolved issues prior to closing a custom home;

FIG. 14 shows a flowchart that identifies processes associated with paying invoices received from builders and vendors in accordance with the present invention;

FIG. 15 illustrates a sample arrangement of databases and user interfaces constructed in accordance with the present invention; and

FIG. 16 is a flowchart that identifies the process of selling a custom home in accordance with the present invention.

### DETAILED DESCRIPTION OF EMBODIMENTS OF THE INVENTION

The present invention provides a system and method for managing parties and tasks associated with the design, construction, contracting to purchase custom designed and built homes. A plurality of computer-related applications preferably receive, process and transmit information regarding builders, subcontractors, homebuyers and custom built homes. The present invention directs the process by improving inter-parties communication, and by providing specific directives to all parties associated with constructing a custom home. The invention is utilized to direct and monitor the project during the entire designing and building process. Moreover, users interact with the invention by transmitting and receiving information related to their respective contributions to a custom homebuilding project via a comprehensive and “user-friendly” Internet web site.

As used herein, the term “web site” refers to a related set of files which are maintained in one or more computer systems, referred to as “web servers” and which, when transmitted to a user terminal, cause a user terminal to display and/or execute programmatic operations corresponding to the data contained in the files. Typically, the files comprising the web site are prepared using one or more of a combination of Hyptertext Mark-Up Language (HTML), Extendable Mark-Up Language (XML), Java Applets, ActiveX programs, Standard Generalized Mark-Up Language (SGML) files and the like. Web site files are typically transmitted to a user terminal using one or more protocols, such as the Hyptertext Transfer Protocol (HTTP) under the Transmission Control Protocol/Internet Protocol (TCP/IP) suite of communication protocols.

Also as used herein, the term “browser” refers to an application program residing and executing on a user terminal which functions as an HTTP client, sending requests to web servers for web site files. A request is typically sent in the form of a Uniform Resource Locator (URL) or by selecting a hypertext link presented on the user terminal display. The browser functions to format the file and/or data received from the web server and format the received files and/or data in the manner described therein, displaying the same on the user terminal. Examples of browser programs include MICROSOFT INTERNET EXPLORER and NETSCAPE NAVIGATOR.

As used herein, the term “link” refers to a selectable connection from one or more words, pictures or other information objects to others in which the selectable connection is presented within the web browser. The information object can include sound and/or motion video. Selection is typically made by “clicking” on the link using an input device such as a mouse, track ball and the like. Of course, one of ordinary skill in the art will appreciate that any method by which an object presented on the screen can be selected is sufficient.

Also as used herein, the term, “construction project” refers, generally, to any building activity. For example, a construction project may include construction of a new custom house or other structure. Alternatively, a construction project may refer to a renovation of an existing, such as, for example, an addition made to a house. Thus, a construction project is not intended to be limited to new buildings or modification to existing buildings.

As used herein, the term, “module,” refers, generally, to one or more discrete components that contribute to the effectiveness of the present invention. Modules can include software elements, including but not limited to functions, algorithms, classes and the like. Modules also include hardware elements, substantially as described below. Modules can operate independently or, alternatively, depend upon one or more other modules in order to function.

Also as used herein, a “franchise region” refers to an area of land capable of receiving a significant number of new home building constructions. Preferably, a franchise region represents an area in the United States where at least 10,000 single-family home building permits are issued annually by housing authorities. A “sales region” represents a region in which prospective custom homebuyers may purchase a custom built home. A sales region also contains a plurality of builders and building subcontractors who are managed under the rules and provisions disclosed herein.

In a preferred embodiment, franchises operate in accordance with the present invention, each interacting with and being managed by Internet web site applications, substantially as described herein. By working with franchises that operate in accordance with the present invention, builders have increased buying advantages, access to improved service and quality, and are able to deliver better custom homes in the sales region in which they operate.

More particularly, franchises utilize the present invention to identify and enter into contractual relationships with a plurality of homebuilders, sub-contractors and vendors operating within a sales region. After builder, sub-contractor and vendor relationships are in place, the invention is preferably used to associate custom homebuyers with the affiliated parties.

In a unique and special way, the invention adds stability and predictability to what has historically been a chaotic segment of the homebuilding industry, the design and build process of a custom home.

In a preferred embodiment, franchises that operate in accordance with the present invention do not physically sell custom homes. Instead, the franchise provides management, support and other services that function to facilitate the designing and building of unique homes on homebuilders' land. As described in detail below, the present invention provides superior predictability over the prior art, and assures an accurate price for a custom built home prior to the custom home's physical construction.

Also as used herein, the term “homebuyer” refers to a person or group of people who purchases custom built homes. Homebuyers first contract the use of the invention and then the services a custom homebuilder to implement construction of custom homes within the use of the invention.

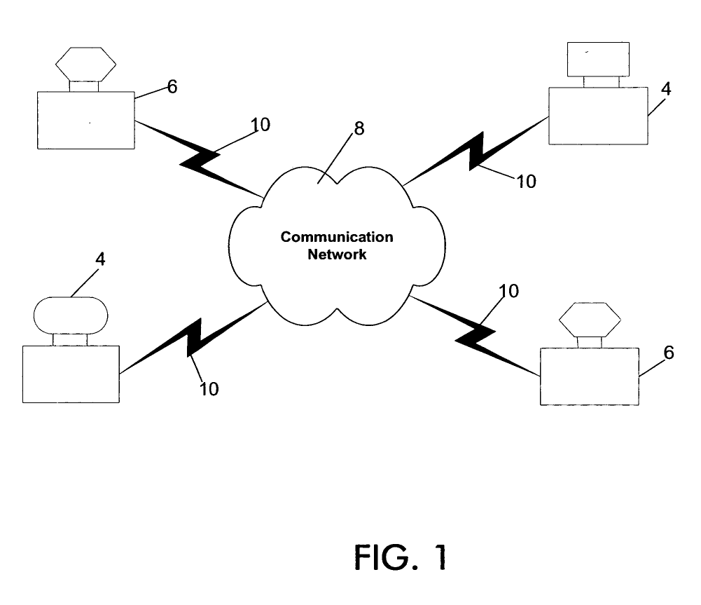

Referring now to the drawings figures in which like reference numerals refer to like elements, there is shown in FIG. 1 a diagram of an example custom homebuilding management system constructed in accordance with the present invention, and designated generally as “custom homebuilding management system 2.” Custom homebuilding management system 2 is preferably comprised of one or more site processors 4 coupled to one or more workstations 6 across communication network 8.

Site processor 4 preferably includes all necessary databases for the present invention. However, it is contemplated that site processor 4 can access any required databases via communication network 8 or any other communication network to which site processor 4 has access. Site processor 4 can communicate devices comprising databases using any known communication method, including a direct serial or parallel interface, or via a local or wide area network.

Workstations 6 communicate with site processors 4 using data connections 10, which are respectively coupled to communication network 8. Communication network 8 can be any communication network, but is typically the Internet or some other global computer network. Data connections 10 can be any known arrangement for accessing communication network 8, such as dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

Workstations 6 preferably have the ability to send and receive data across communication network 8, and are equipped with web browsers to display the received data on display devices incorporated therewith. By way of example, workstation 6 may be personal computers such as Intel Pentium-class computers or Apple Macintosh computers, but are not limited to such computers. Other terminals which can communicate over a global computer network such as palmtop computers, personal digital assistants (PDAs) and mass-marketed Internet access devices such as WebTV can be used. In addition, the hardware arrangement of the present invention is not limited to devices that are physically wired to communication network 8. Of course, one skilled in the art will recognize that wireless devices can communicate with site processors 4 using wireless data communication connections (e.g., WIFI).

In addition to computer-related methods to access the system, parties who are not able to access the custom homebuilding management system 2 via a computer or related device can write physical letters, make telephone calls or facsimiles to parties operating in accordance with the present invention. For example, after a letter and/or telephone call is received, data-entry personnel make the necessary entries into custom homebuilding management system 2.

According to the present invention, workstation 6 provides user access to site processor 4 for the purpose of receiving and providing custom homebuilding-related information. The specific functionality provided by custom homebuilding management system 2, and in particular site processors 4, is described in detail below.

Custom homebuilding management system 2 employs software that controls custom homebuilding management functions and preferably resides on one or more site processors 4. One of the functions performed by site processor 4 is that of operating as a web server and/or a web site host. Site processors 4 typically communicate with communication network 8 across a permanent i.e., unswitched data connection 10. Permanent connectivity ensures that access to site processors 4 is always available.

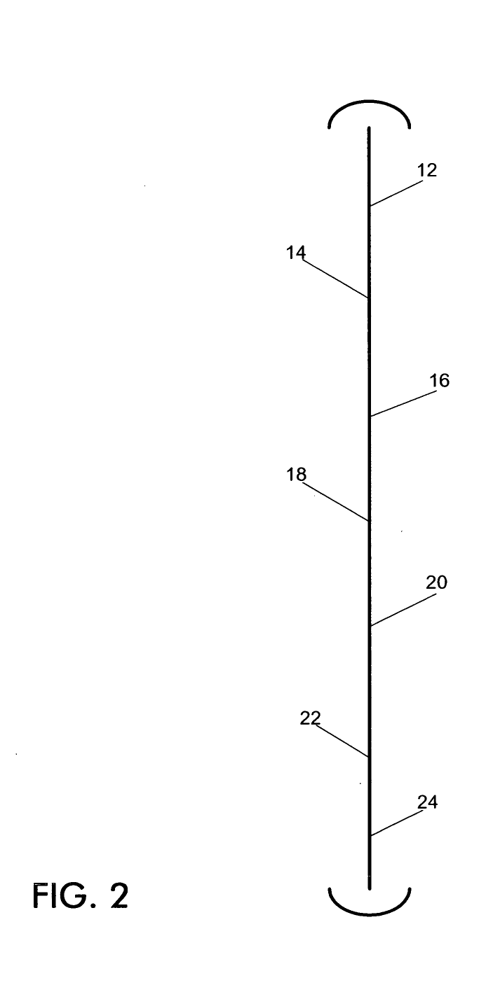

As shown in FIG. 2 the functional elements of each site processor 4 preferably include one or more central processing units (CPU) 12 used to execute software code in order to control the operation of site processor 4, read only memory (ROM) 14, random access memory (RAM) 16, one or more network interfaces 18 to transmit and receive data to and from other computing devices across a communication network, storage devices 20 such as a hard disk drive, floppy disk drive, tape drive, CD-ROM or DVD drive for storing program code, databases and application code, one or more input devices 22 such as a keyboard, mouse, track ball and the like, and a display 24.

The various components of site processor 4 need not be physically contained within the same chassis or even located in a single location. For example, as explained above with respect to databases which can reside on storage device 20, storage device 20 may be located at a site which is remote from the remaining elements of site processors 4, and may even be connected to CPU 12 across communication network 8 via network interface 18.

The functional elements shown in FIG. 2 (designated by reference numbers 12-24) are preferably the same categories of functional elements preferably present in workstation 6. However, not all elements need be present, for example, storage devices in the case of PDAs, and the capacities of the various elements are arranged to accommodate expected user demand. For example, CPU 12 in workstation 6 may be of a smaller capacity than CPU 12 as present in site processor 4. Similarly, it is likely that site processor 4 will include storage devices 20 of a much higher capacity than storage devices 20 present in work station 6. Of course, one of ordinary skill in the art will understand that the capacities of the functional elements can be adjusted as needed.

The nature of the present invention is such that one skilled in the art of writing computer executed code (software) can implement the described functions using one or more or a combination of a popular computer programming language including but not limited to “C++”, Visual Basic, Java, ActiveX, HTML, and web application development environments.

As used herein, references to displaying data on workstation 6 refer to the process of communicating data to the terminal across communication network 8 and processing the data such that the data can be viewed on the work station display 24 using a web browser or the like. The display screen on terminal 6 present areas within custom homebuilding management system 2 such that a user can proceed from area to area within the custom homebuilding management system 2 by selecting a desired link. Therefore, each user's experience with custom homebuilding management system 2 will be based on the order with which they progress through the display screens. In other words, because the system is not completely hierarchical in its arrangement of display screens, users can proceed from area to area without the need to “backtrack” through a series of display screens. For that reason, unless stated otherwise, the following discussion is not intended to represent any sequential operation steps, but rather the discussion of the components of custom homebuilding management system 2.

Although the present invention is described by way of example herein in terms of a web-based system using web browsers and a web site server (site processor 4), custom homebuilding management system 2 is not limited to that particular configuration. It is contemplated that custom homebuilding management system 2 can be arranged such that work station 6 can communicate with, and display data received from, site processor 4 using any known communication and display method, for example, using a non-Internet browser Windows viewer coupled with a local area network protocol such as the Internetwork Packet Exchange (IPX). It is further contemplated that any suitable operating system can be used on workstation 6, for example, Windows 3.x, Windows 95, Windows 98, Windows CE, Windows NT, LINUX and any suitable PDA or palm computer operating system.

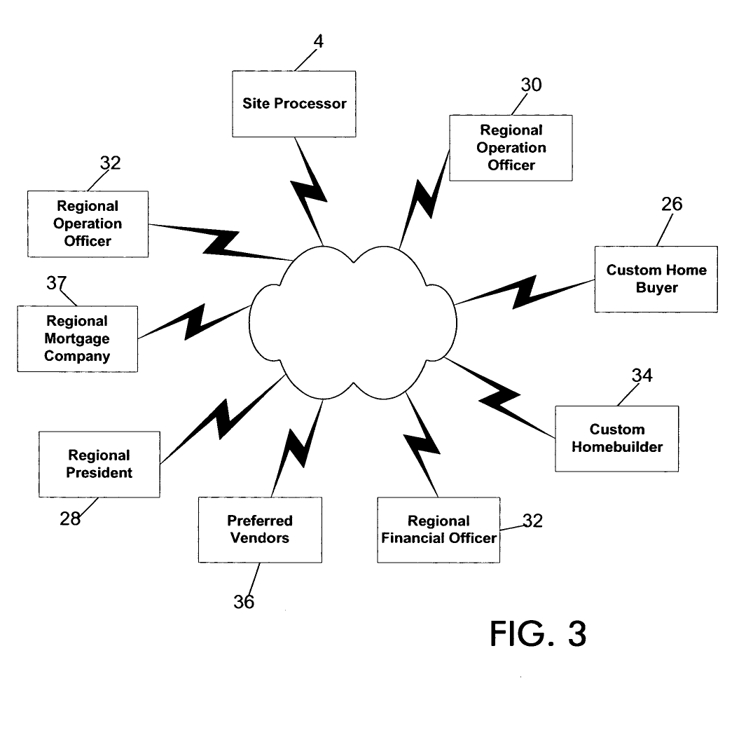

FIG. 3 shows an arrangement of many key parties and devices associated with building a custom home in accordance with the present invention. As shown in FIG. 3, a custom homebuyer 26, regional president 28, regional operations officer 30, regional financial officer 32, homebuilder 34, preferred vendors 36 and regional mortgage company 37 interact via communications network 8 to implement the processes of the present invention, to, accordingly, construct a custom home.

As used herein, a regional president 28 refers to a person who provides management and sales services in accordance with the present invention. The regional president's 28 duties include developing and maintaining contractual relationships with builders and building subcontractors. Moreover, the regional president 28 frequently meets prospective custom homebuyers 26 to introduce the benefits of the present invention, and to negotiate a final, binding sales contract with them.

Regional presidents 28 are also preferably responsible for establishing one or more new sales regions. As part of the new sales region establishment, builders 34 are researched through, for example, credential and background checking. Eligible builders 34 are preferably recruited by the regional president 28, and at least one interview is scheduled, and, when appropriate, an application for participating with the regional president 28 in accordance with the present invention is received from the builder 34. If the regional president 28 is satisfied with the ability of the builder 34, then a contract is executed between the builder 34 and the regional president 28. In accordance with the present invention, builders 34 must commit to particular building and operational standards prior to operating within and benefiting by the present invention.

Also as used herein, a regional operations officer 30 refers to a person who performs many approval and management duties during the custom homebuilding process. For example, the regional operations officer 30 approves and implements terms of sales contracts developed by the regional president 28 and custom homebuyer 26. During the process of approving a contract, the regional operations officer 30 queries databases included in the present invention to determine whether a custom homebuilding project will be practical and profitable. For example, a regional financial officer 32 maintains price lists regarding labor and materials offered by builders 34 and vendors 36 within a given sales region. The regional operations officer 30 uses the price list information to determine whether construction of a custom home is cost or time prohibitive. If a preliminary evaluation leads the regional operations officer 30 to determine that a specific custom homebuilding project would not be profitable or has design problems, the regional operations officer 30 and regional president 28 preferably meet with the prospective custom homebuyer 26 to modify design parameters of the custom home.

During a new home construction, the regional operations officer 30 preferably regularly meets with builders 34 and custom homebuyers 26 to ensure that contractual terms are being adhered to, and that the building project is on schedule. A regional operations officer 30 may also be responsible, for example, for managing subcontractors, materials and labor required for the completion of a custom home. The regional operations officer 30 preferably ensures that jobs and materials needed for custom homebuilding process are provided in accordance with the present invention. Overseeing jobs performed by subcontractors and ensuring schedules are maintained improves the accuracy of estimated quotes at the outset of the process between the regional president 28 and a custom homebuyer 26.

Regional operations officers 30 further provide information in custom homebuilding management system 2 that is used to manage estimators, designers, and budget experts as detailed specifications of a custom home are developed. The regional operations officer 30 preferably approves and enforces contracts that are developed between the regional president 28 and the prospective custom homebuyer 26. Further, the regional operations officer 30 ensures that builders 34 and vendors 36 provide and adhere to strict pricing guidelines and job schedules.

As used herein, a financial officer 32 refers to a person who performs financial services in accordance with the present invention. The financial officer 32 is responsible for job accounting and monitoring the financial progress of custom homebuilding projects. The financial officer 32 submits and maintains financial information in the custom homebuilding management system 2. The information is used to present detailed and accurate cost estimates of a custom home, including, for example, labor and materials. The information transmitted by the financial officer 32 is processed by the custom homebuilding management system 2 to provide useful information for marketing and selling custom homes.

In accordance with the present invention, a regional mortgage company 37 is used for providing home mortgages for homebuyers 26. The regional financial officer 32 works with the regional mortgage company 37, as described in detail below. In an effort designed to remove control of funds as a tool that can be used by either homebuyers, builders or vendors, the homebuyer 26 is preferably restricted from using a different mortgage loan company. This is accomplished in a relationship forged between the regional financial officer 32 and the regional mortgage company 37 to ensure a level of control over capital funds during the building of custom homes. The present invention strives to prevent homebuyers 26 from leveraging funds to ensure compliance, and further to prevent homebuilders or vendors from getting paid for substandard labor and materials.

In accordance with the present invention, one or more financial accounts are under control of the financial officer 32 and used to pay the many costs associated with building a custom home. The financial officer 32 draws funds from the accounts and is responsible for reviewing, approving and accounting for, for example, construction loans, payments to builders, suppliers, and subcontractors. As a part of the invention, homebuyers, builders and vendors authorize draws and disbursements to be handled by regional financial officers utilizing the invention.

In a preferred embodiment of the invention, homebuyers, homebuilders and vendors enter into a membership. For example, the homebuyers 26 pay a membership fee that enable them access to work with the regional president 28 who has access to network of vendors and automated processes described herein. Homebuilders 34 pay a membership fee that provides them with access to the network of vendors for tasks associated with building a new home. Moreover, the homebuilders 34 are afforded access to homebuyers 26 for generation of new business. The homebuilders 34 are afforded access to the many automated processes described herein. Vendors 36 also pay a membership fee to participate in the present invention and are, likewise, afforded access to many work projects that may not have otherwise been available to them. Such a membership process ensures a stream of capital for the franchise operation that, preferably, uses the fees received from the members to perpetually improve the system and processes described herein.

The inventor believes that various critical problem points relating to marketing, designing, financing and building exist for any new custom homebuilding project. For other types of custom homebuilding projects, such as renovations and additions, a subset of those critical problem points are faced. It is further believed that any one or more of these critical problem points must be properly handled to avoid an issue that negatively impacts the custom homebuilding project, possibly irrevocably. Moreover, any one of these issues may have emotional consequences if not proactively addressed by the parties. Further, the inventor believes that in the prior art small homebuilders fail to recognize many of these critical problem points, and are thus not prepared to address unexpected issues during a custom homebuilding project. Accordingly, the present invention preferably proactively handles critical problem points to avoid the points evolving into an issue that can jeopardize successfully implementation of a custom homebuilding project.

For example, in many instances when a home site is cleared and the homebuyer 26 is not present on the site during the clearing process, an unexpected and negative emotional response is realized by the homebuyer 26 when the site is visited after the clearing. Even though the number of trees that are removed may be exactly what was planned by the parties, the homebuyer 26 was simply not prepared for viewing the site in such a changed condition. The present invention preferably addresses such issues by requiring both the custom homebuilder 34 and homebuyer 26 to agree in advance to various activity, such as to be present during the clearing process. Alternatively, the homebuyer 26 may be prepared for the shock of seeing his landscape altered by previewing “before and after” video or images of other sites that have been cleared.

In another example many homes are not built straight-level and square which results in doors and windows not opening and/or closing properly which similarly triggers negative emotional responses by homebuyers 26. In accordance with the present invention, a registered surveyor surveys a foundation prior to the framing stage beginning in order to certify that the foundation is straight, level and square. In this way, doors and windows will function normally. This is a unique improvement over prior art building techniques.

In yet another example and described in greater detail below, the present invention manages the disbursement of construction funds. Preferably, a relationship is forged such that at least ten reviews of disbursements and draws on construction loans are performed by a licensed attorney functioning as a trustee after completion of various tasks. This certifies to homebuyers 26 and lenders that appropriate parties are compensated and decreases the likelihood that a custom construction project will incur a lien. In addition to certifying a title is lien-free, the attorney-trustee verifies that each payment made during the course of a custom homebuilding project is received by the appropriate party, thereby ensuring lien-free project.

Thus, the present invention anticipates many hundreds of issues that would unexpectedly arise in the prior art, and puts the parties to a custom homebuilding project on notice of such issues. In this way, the negative emotional component that is experienced during a custom homebuilding project is offset and the project is more enjoyable and successful as a result.

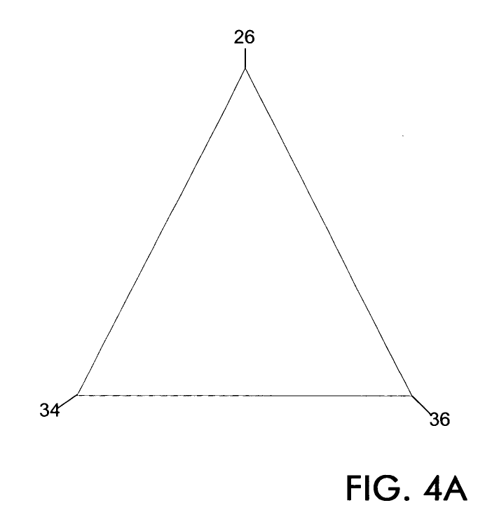

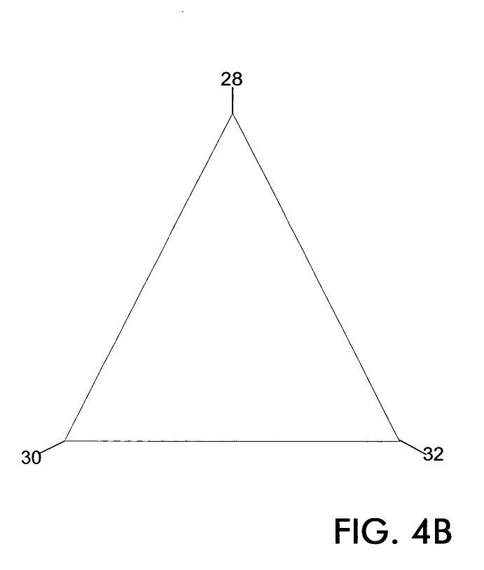

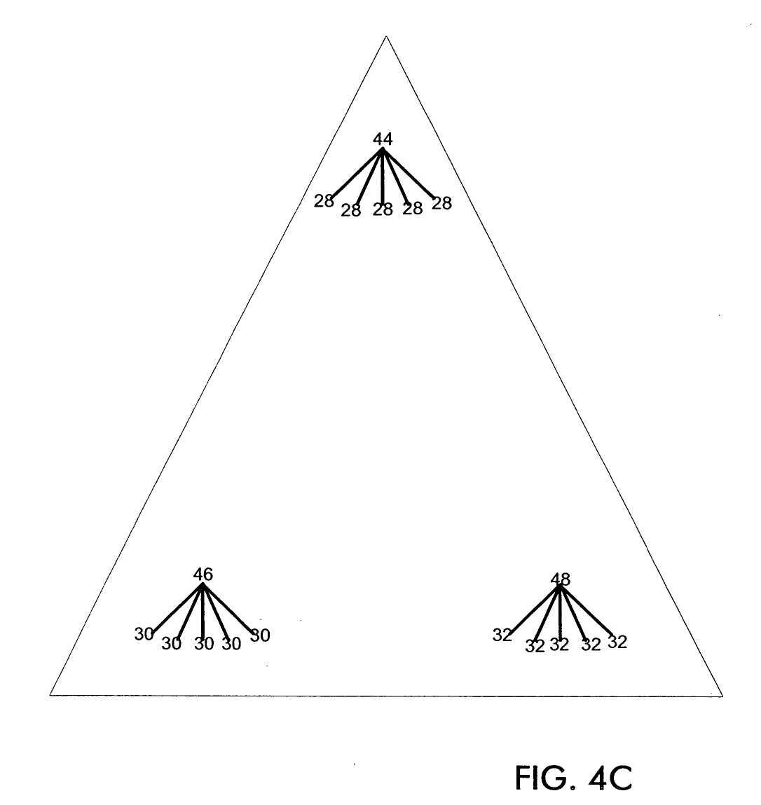

FIGS. 4A, FIG. 4B, and 4C illustrate parties and respective relationships between the parties operating in accordance with the present invention.

For purposes of describing the present invention, reference is made to a triangle structure to represent the many facets of, and to describe, the present invention. In the example shown in FIG. 4A, the angles of the triangle represent three categories of parties related via the custom homebuilding process. One angle represents custom homebuyers 26, a second angle represents a homebuilder 34 and the third angle represents vendors 36, representing all vendors of goods and services that are required in the custom homebuilding process. The parties are so categorized, in part, because the contributions they make to custom homebuilding can be grouped into specific categories. For example, homebuyers 26 make financial and design contributions. Builders 34 make management and implementation contributions, and sub-contractors, vendors and other professionals make specific task and component contributions.

The invention is preferably utilized to divide the custom design and build process into three sections. The needs and desires of custom homebuyers 26 are represented in one angle, homebuilders 34 who are being asked to manage the building process are represented in a second angle, and all vendors and subcontractors required to complete the design/build project are represented in a third angle. The three angles and those represented within the angles illustrate each and every component of the design build process. Prior to the design phase of the custom home project beginning, the contracting phase of the invention is utilized to establish order by and between all of the parties that will be involved. This is believed by the inventor to be impossible in the prior art. The present invention functions in the center of the design/build triangle effectively for all of the parties to predict the outcome of the project.

In part due to custom home designing and building processes, the emotional experiences of the parties can also be categorized. For example, for homebuyers 26, the custom homebuilding experience is typically very emotional and often stressful. A significant financial, time and personal investment is often made by homebuyers 26 prior to and during the custom home designing and building process. Moreover, designers and architects are categorized herein as creative parties, largely due to the creative skills demanded of them for successful custom home design.

The lines in the triangle shown in FIG. 4A can also be seen to represent the professional interactions between the above-described parties. Preferably, the parties (or representatives thereof) transmit information to the custom home designing and building management system 2 during the custom homebuilding process. The system 2 preferably processes the information and provides accurate and complete detailed and summary cost estimates for the custom home. Since much information is gathered and processed electronically, the present invention manages, and in some cases prevents, interaction between respective parties in the custom homebuilding process. Generally speaking, creative personalities do not always function well with non-creative personalities. Therefore, in accordance with the present invention, the parties are managed to maximize efficiency and effectiveness. For example, designers are mostly interested in style, and budget experts are responsible for costs. Since it is seldom that the two individuals can agree on specific design and costs issues, the invention does not allow these parties to interface with each other. The invention places such responsibilities in the hands of the regional operations officer 30, a third party to the design versus. costs analysis.

Although, as shown in FIG. 4A, the parties comprise a custom homebuyer 26, homebuilder 34 and preferred vendors 36, the present invention preferably allows homebuyers to have an active role in the construction of the custom home. The custom homebuyer 26 may have building skills and experience with respect to construction of homes. In such case, and further to offer the custom homebuyer 26 a reduction in the overall cost of a custom home construction, the present invention preferably enables the homebuyer to play a dual role of the custom homebuyer 26 and the homebuilder 34. In such case, the custom homebuyer 26 while functioning as a homebuilder 34, is bound to the rules and procedures disclosed herein.

For example, the custom homebuyer 26 who acts as a homebuilder 34, is not entitled to use his or her own network of vendors and subcontractors during the new home construction. Instead, as with all homebuilders 34, the custom homebuyer 26 is required to use the preferred vendors 36 that are contractually retained by the present invention to provide their respective services and materials. This feature of the present invention offers flexibility to custom homebuyers 26 in order to capitalize on their building and construction experience and to contribute to the construction of the custom home.

Alternatively, the present invention preferably enables custom homebuyers 26 to contribute some labor to the custom homebuilding project, without performing as builders 34. In this way, homebuyers 26 can realize a discount on the total cost of the project. For example, a custom homebuyer 26 may decide that he wishes to paint all of the rooms in the interior of the house. In accordance with the present invention, custom homebuyer 21 is entitled to do so, and is awarded a percentage discount on the labor associated with painting rooms when the budget is prepared and the total cost of the custom home is calculated.

FIG. 4B also illustrates a triangle that includes three pivotal categories of parties associated with the custom homebuilding management system 2. As shown in FIG. 4B, the regional president 28, regional operations officer 30 and regional financial officer 32 function to ensure that specific tasks are completed in a timely, efficient, and proper way.

In the United States, approximately fifty sales regions are estimated to be available for use by the present invention. Since each sales region preferably comprises 10,000 new home permits, this accounts for approximately 1,000,000 new home construction permits being issued a year. In a preferred embodiment, one regional president 28, one regional operation officer 30 and one regional financial officer 32 operate in each respective region concurrently. It is envisioned, therefore, that a plurality of people may assist the parties shown in FIG. 4B by being delegated many of the tasks assigned herein to the parties shown in FIG. 4B. However, the three parties shown in FIG. 4B are responsible for the activities occurring in their respective region.

Referring now to FIG. 4C, the regional president 28, regional operations officer 30, and regional financial officer 32 are overseen and managed by respective national counterparts. A national president 44 oversees a plurality of regional presidents 28 by maintaining regular and personal contact with each of the regional presidents 28 via the present invention. Also shown in FIG. 4C, a national operations officer 46 oversees a plurality of regional operations officers 30. Moreover, a national financial officer 48 oversees the regional financial officers 32. By providing national counterparts to the regional parties, efficient management of personnel operating in accordance with the present invention improves the likelihood of successful resolution to unexpected issues and/or confrontations experienced in the prior art. Custom homebuyers 26 are assured by the present invention that they will receive quality and value in their custom-built home.

In accordance with the present invention, each regional president 28, regional operations officer 30 and regional financial officer 32 (collectively referred to herein as “regional officers”) provides information regarding himself and associated projects in a database provided by the custom homebuilding management system 2. The information received and stored therein is preferably available in a variety of forms to users of the custom homebuilding management system 2, for example, via on-line data entry forms, reports, automatic e-mail notifications, facsimiles and the like. The regional officers' national counterparts also preferably have web pages containing information directed to them, and communicate, for example, using remote on-line video-conferencing, e-mail, telephone and in-person meetings. The regional officers preferably regularly communicate with their national counterparts via the present invention using known Internet functionality.

In accordance with the present invention, a plurality of users operate the custom homebuilding management system 2 concurrently. Each user is afforded a specific level of access that is defined during an initial registration process. Initially, a user registers with the custom homebuilding management system 2 by providing information regarding the user and the user's intended use of the system. A determination is made regarding a degree of access to information that should be granted to the user. For example, while a custom homebuyer 26 is afforded limited access to schedule information regarding his custom home project, while the national president 44 is authorized to access information, for example, budgets, performance, and correspondence between the parties associated with the project. Techniques of restricting and securing access to the custom homebuilding management system 2 and corresponding Internet web sites, for example, by Secured Sockets Layer (“SSL”) are known. Of course, one skilled in the art will recognize that security authorization can be modified over time.

The present invention preferably operates to receive information directed to a custom homebuilding project, to process the information, to provide processed information to a plurality of parties, and, thereafter, to receive new information, or modified processed information, regarding the completed custom home building project. By receiving information directed to completed projects, the present invention maintains regularly updated databases that are used to provide current information for, among other things, providing cost estimates. This module of the invention provides access to the smallest builder involved in the system to a huge database that is continually updated by other users of the invention.

More particularly, the databases associated with the present invention preferably comprise a plurality of files for storing data, for example, data tables, spreadsheets, text files and any other format. Information stored therein includes data representing, for example, builders 34, vendors 36 and custom homebuyers 26. Other information stored in the databases includes data representing sales regions, training processes for regional presidents 28, regional operations officers 30 and regional financial officer 32, and a plurality of cost information, for example, costs of building permits, preparation of plans, budgets, engineering services, subcontracted labor, materials and builder management fees.

Preferably, the databases included in the present invention also provide complete and regularly updated details of building designs and specifications. For example, a plurality of house designs are available for preview via an Internet web page and used, in part, for designing a new home custom home.

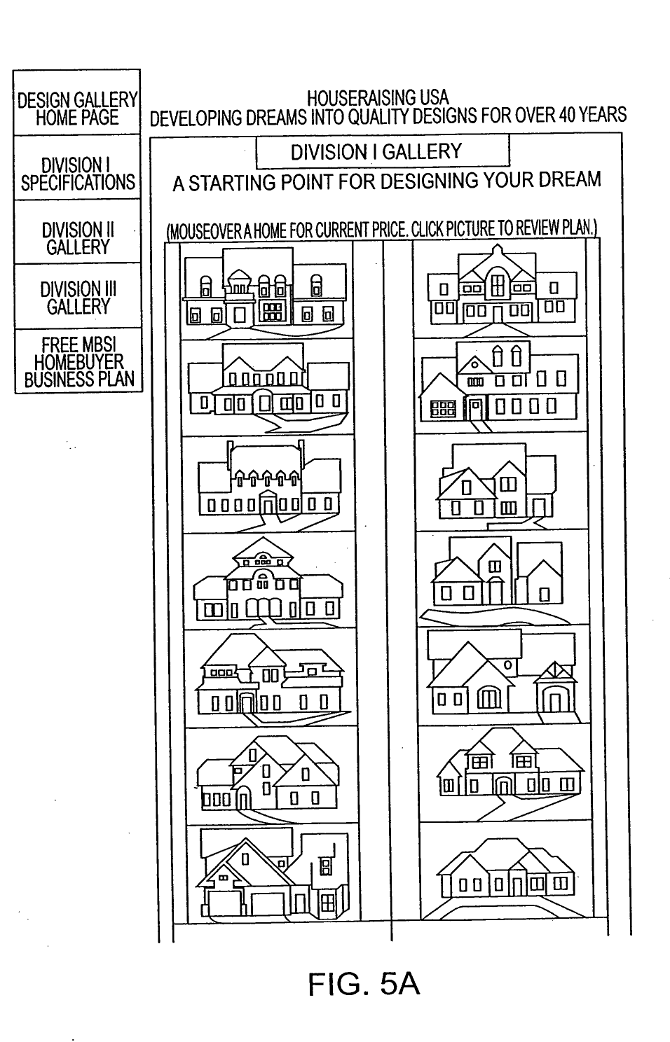

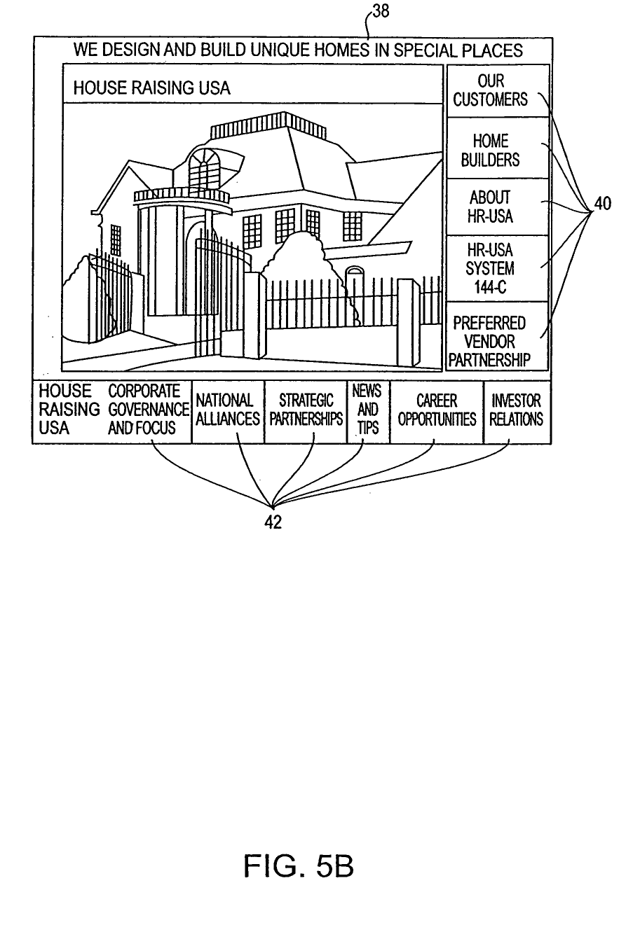

FIG. 5A shows an example display screen of an Internet web site that presents standard house designs. After a “starting point” selection is made from standard house designs, data representing the design, including square footage, style and costs are preferably provided. These data are used to create unique home plans and to solicit new business, to generate accurate estimates of the costs for building a custom home, and to complete the sale of a custom designed and built home project.

In accordance with the present invention, the regional president 28, interacts with a potential custom homebuyer 26, either in person or remotely, and operates the system 2 to transmit information in response to prompts and instructions provided by the present invention to guide the regional president 28 during the selling process. For example, the regional president 28 is prompted to enter design data such as square footage, style and building materials to be used for the custom home. The system processes the information to generate a suggested design and cost of the entire project.

In a preferred embodiment, the present invention classifies custom houses in three cost categories. Division 1 houses cost between $150,000 and $400,000, Division 2 houses cost between $400,000 and $800,000 and Division 3 houses cost between $800,000 and $3,000,000. Preferably, each division has shared characteristics, such as square footage, style and materials that a pricing module uses to estimate the cost of custom houses. For example, a Division 1 house has a siding, such as vinyl, that is less expensive than siding, for example, stone, used in a Division 3 house. The particular division of house that is purchased is, typically, limited by the buyer's financial ability.

As noted above, the custom homebuilding management system 2 receives information from an operator and processes the information to provide detailed and accurate estimates of the final cost of a custom home. In a preferred embodiment of the present invention, a pricing module contains price matrices including, for example, database files, spreadsheet files, text files and the like, that contain price information associated with substantially all of the components for building the above-described custom homes. Preferably, after a custom house is categorized into one of the three divisions, modifications to the custom house are made, for example, by adding and substituting features and materials that belong to a different division. For example, stone siding, typically a Division 3 feature, can be applied to a Division 1 house. If stone siding is applied to a Division 1 house, the cost of the Division 1 house is preferably increased, for example, from $240,000 (with vinyl siding) to $300,000 (with stone siding).

As noted above, many features of the custom homebuilding management system 2 are preferably arranged as a web site through which the user selects choices and functions. Initially, a user accesses the web site provided by site processor 4 by entering an Internet address (or a URL) corresponding to the web site. Once the web site is accessed, the user is presented with a home page comprising a main menu, preferably similar to the display screen as shown in FIG. 5B.

FIG. 5B illustrates a custom homebuilding management system main menu display screen 38 that is provided to users of custom homebuilding management system 2. The example shown in FIG. 5B is one embodiment of the present invention; of course, other design layouts could be fashioned using other types of graphic display controls known to those skilled in the art. The example main menu 38 shown in FIG. 5 is preferably comprised of one or more graphic controls including, but not limited to, images, title bars, labels, navigation bars, and the like. When selecting these or similar controls, content corresponding to the selected button is caused to be displayed in the same or another web page. Initially, custom homebuilding management system main menu display screen 38 is presented in the case where a user has not made a particular choice.

The functionality provided in the custom homebuilding management system menu display screen 38 includes access to information for the parties associated with building a custom home, individual custom home building projects, employment opportunities, and franchise information. As shown in FIG. 5B, navigation bar 40 provides access to information for custom homebuyers 26, builders 34, vendors 36, and regional officers. Navigation bar 42 provides information directed to custom homebuilding projects, partnerships, news information, career opportunities and the like. A user of the present invention preferably makes a selection from the above described choices, and operates the system and implement the functionality described herein.

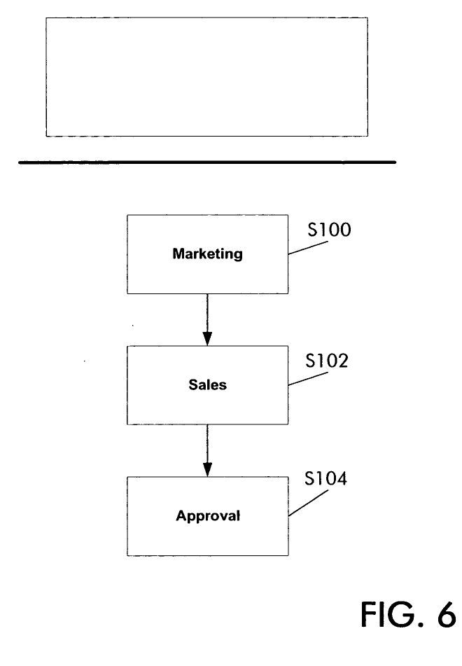

In accordance with the present invention, and illustrated in FIG. 6, a series of procedural steps are used to manage the parties and processes associated with custom home building. As shown in FIG. 6, in order to inform prospective custom homebuyers 26 of the present invention, national, regional and local marketing is performed (step S100). More specifically, sales personnel may contact prospective homebuyers, for example, through direct contact (in-person or telephone contact) and indirect contact (mailings, e-mail, and Internet) channels. Eventually, sales personnel commit potential custom homebuyers 26 to schedule appointments with a regional president 28. In accordance with the present invention, sales personnel group potential homebuyers into categories, and the specific categories of potential buyers are specifically targeted in advertising and marketing campaigns. For example, a potential homebuyer who does not own a home, but owns land is considered a more likely candidate for contracting for the sale of a custom design and build project. Moreover, a party who has inherited land and wants to build a custom home thereon is also considered a more likely candidate to contract for the sale of a custom home.

Other categories of potential buyers include: those who do not own a home and do not own a tract of land; friends, family and neighbors of recent custom homebuyers 26 that contracted with operators of the present invention; current homeowners waiting to sell their home prior to purchasing a lot and developing a custom home; current homeowners that have purchased a lot but have not sold their current home; parties who are not homeowner, and own a tract of land and have developed plans; retirees who are seeking to build a custom home; and realtor-developed and controlled contacts who seek to design and build custom homes. The likelihood of success of entering into a binding contractual relationship with the parties is predictable based upon the category and marketing approach suggested by the invention for use by sales personnel meeting with the prospective custom home buyer 26.

Moreover, a marketing budget is preferably used that earmarks specific cash allowances for particular marketing strategies. For example, regional sales staff works directly with individual lot owners in different contexts, for example, by participating in home shows. Further, costs associated with advertising in a plurality of media including printed media, television, radio and Internet web sites are budgeted.

In accordance with the present invention, the cost of marketing in a sales region is expected to decrease over time. As a regional president 28 operates within a sales region over time, the number of initial contacts that are made increases over time. For example, in the first year of a new sales region, 718 contacts may be made that result in twenty approved and enforceable contracts being entered into with the custom homebuyer 26. Over the course of the next three years, the number of initial contacts made with prospective homebuyers increases to over 5,000, in large part due to the marketing campaign carried out over the years. The number of approved and enforceable contracts entered into with prospective custom homebuyers 26 increases from 20 in year #1 to over 140 in year #4.

In addition to the process of marketing the present invention, entering into a binding contract with an individual custom homebuyer 26 is implemented with respect to sales (step S102). During the sales process, a scheduled appointment with the regional president 28 is preferably made for the prospective custom homebuyer 26. During the appointment with the regional president 28, the prospective custom homebuyer 26 is shown a large variety of custom home designs, such as shown in FIG. 5A.

In addition to plans and specifications that are provided electronically, the prospective custom homebuyer 26 is preferably presented an estimated cost for the custom designed home project. Upon deciding on a plan, the buyer's financial status is evaluated as part of the cost estimate, for example, through a preliminary loan approval process. In a preferred embodiment of the present invention, the regional president 28 establishes a new data entry record for the prospective custom homebuilding project. For example, an Internet web page is created that receives, stores and displays information regarding the prospective project. The regional president 28 preferably provides background information on the prospective custom homebuyer 26. Other information, for example, demographic information including name, address, e-mail, telephone and the like, as well as descriptions of the prospective custom homebuyer's 26 current home and any tract of land owned by the prospective custom homebuyer 26 are preferably submitted in the system 2.

In addition to information regarding the prospective custom homebuyer 26, the regional president 28 preferably retrieves information regarding the physical specifications of the custom home that the prospective custom homebuyer 26 desires. For example, the regional president 28 preferably selects screen-controls (e.g., drop-down lists, text boxes check-boxes, and the like) to indicate the style of the home (e.g., a ranch, one and a half story house, two-story house), other features (e.g., basement, garage, veranda or front entry porch), and sizes and locations of rooms (e.g., living room, dining room, den and study). Additionally, the regional president 28 provides, for example, the number of bedrooms in the new home, the floor where the master suite is located, the number and arrangement of baths and the like.

The kinds of financial information provided by the regional president 28 include, for example, the maximum down payment amount a prospective homebuyer 26 can afford, a maximum monthly payment amount the homebuyer can afford, and the type, size and description of a tract of land owned by the prospective custom homebuyer 26 (as potential equity).

After entering the financial information, such as the homebuyer's total annual income, a series of values are preferably automatically determined by the present invention which prompts a total monthly payment (for example, the annual income divided by 12, multiplied by 28%, minus the monthly payment of taxes and insurance, and less of the allowance (PMI) payments, if applicable). This value nets to the amount allowed for the principal and interest payments for a given month. By taking that value and dividing it by the current interest rate factor per 1,000, the regional president 28 is automatically provided with an approximate amount of a loan for which a homebuyer will be qualified to receive from a lending institution. Other information directed for financing qualifications include equity that is available from an existing home, and any equity available from a new tract of land and extra cash which may be available for additional down payments.

Other information received by the custom homebuilding management system 2 during early sales negotiations between the regional president 28 and prospective custom homebuyer 26 include details of the site where the custom home is to be built and includes, for example, the value of the lot, the amount of money owed on the lot, water and sewer costs, any unusual improvement costs and a description of lot.

Preferably, after the above-identified information is entered by the regional president 28 in the custom homebuilding management system 2, a custom homebuilding plan with associated costs is developed. The system 2 preferably processes the information received during the sales meeting between the prospective custom homebuyer 26 and the regional president 28, and generates output, for example, to a display screen 24 or a printer. The system 2 preferably provides a description of the custom home plan, the size of a heated square feet area, an estimated price per square foot of the heated area, the total area square footage under the roof, and the suggested price per square feet under the roof. Moreover, the system 2 outputs the specification level (Division 1, 2 or 3), the custom home sale price, and additional costs for optional modifications, and the total price for the custom home. The system 2 also outputs detailed home pricing analysis that includes other costs including, for example, the lot price and financing costs which are added to the estimated costs of the custom home in order to generate a total project allowance. Further, the new prospective custom homebuyer 26 is preferably required to sign a mortgage loan credit report release that authorizes users the present invention to obtain and review credit reports.

After the regional president 28 and the prospective custom homebuyer 26 are satisfied with the plans, specifications, and estimated costs associated with building the custom home, the regional operations officer 30 preferably initiates an approval process by developing final plans, specifications, budgets and pricing along with mortgage loan approvals (step S104).

During the approval process, the regional operations officer 30 preferably uses the contract received from the regional president 28 and develops a working budget therefrom. Acting independently, the regional operations officer 30 develops preliminary sketches and cost estimates that contribute to the operating officer's decision to approve or reject a custom house project received from the regional president 28. The regional operations officer 32 preferably develops contracts for many, if not all, of the vendors contributing to the custom house. In this way, the regional president 28, who is involved largely in sales processes, is precluded from deciding which custom houses projects are undertaken.

The design specifications and cost estimates generated by the present invention during the sales process in step S102 may not be totally accurate because of unforeseen details, for example, with respect to the physical site location for the new home construction, unforeseen building costs (e.g., plan changes, water and sewer costs, and financing costs), and other indirect costs, such as realtor fees. Moreover, the sales contract comprising the design specifications and cost estimates for the custom home are preferably reviewed carefully by budget specialists and architects to determine if the contract, architecture and budgeting are feasible. For example, modifications to standard plans may compromise structural or aesthetic features of the proposed design, thereby rendering the contract unfeasible. Further, some modifications may require a complete redesign of the standard plan and specifications and take a significant number of hours to change or redraw.

Budget specialists review the design specifications and estimated costs and determine whether or not additional costs are required in order to implement the custom home design. Occasionally, a complete re-budgeting of the standard plans and specifications will demand several hours to complete.

In addition to the architectural and budget concerns, a person charged with reviewing the contractual and financial terms of the contract will determine whether the project is feasible and should be approved based upon any preliminary loan approval for the homebuyer. The regional operations officer 30 enters information into system 2 whether or not approval for the project is given. In the event that approval is not given for a sales contract, the regional operations officer 30 preferably submits preliminary reviews describing the reasons for the decision, and particular issues that should be addressed.

In accordance with the present invention, information directed to the tract of land where the custom home will be built is entered into the custom home management system 2 and processed therein. For example, the cost of a building permit for the site is determined, fees and expenses required to obtain a Certificate of Occupancy is submitted, and any other impact fees or costs associated with a custom home on the specific tract of land are estimated. Moreover, sewer and water hook-up fees are determined, whether any portion of this site is located in a flood plane and any other recorded deed restrictions are provided. Moreover, a comparison of the budgeted allowances identified in the sales contract by the prospective custom homebuyer 26 is made. Details that are received by the present invention include the condition of the site, for example, whether the site is heavily wooded, comprises mixed trees or open. Any additional costs associated with removing, for example, stumps, are also estimated.

Further, information directed to the condition of the soil is entered into the custom homebuilding management system 2, for example, whether the soil is damp, soft, rocky, well-trained or comprises good clay is preferably submitted. Further, the regional operations officer enters information directed to anticipated additional costs directed to digging and compacting the footings for the new house, whether the conditions of the elevation and grade of the site (e.g., level or sloping), are also entered.

The present invention also receives information directed to the elevation of the property (e.g., number of feet and inches above or below street level) and, the elevation of the property above or below the street level in the different areas of the house, for example, the right front of the house, the left front of the house, the right rear and the left rear of the house. Other information during the site inspection is the general condition of the foundation, degree of the slope and raised concrete floors and crawl spaces, landscaping costs, length and width of walks and driveways, sewer and water hookup costs or the like.

After the information retrieved during the site inspection and entered into custom homebuilding management system 2 is received, system 2 preferably processes the information to determine whether the contract that is entered into at the time of the sales meeting between the regional president 28 and the prospective custom homebuyer 26 (step S102, FIG. 6) is feasible.

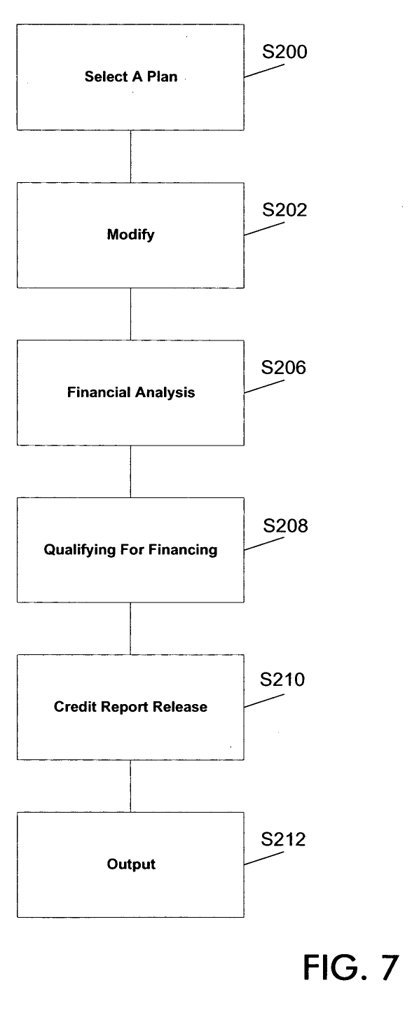

FIG. 7 is a flowchart identifying steps associated with the sales processes during the meeting between the regional president 28 and prospective custom homebuyers 26. As shown in FIG. 7, the regional president 28 follows directives from the prospective custom homebuyer 26 and operates the custom homebuilding management system 2 to view a series of custom home plans (step S200). In step S202, the regional president 28 and custom homebuyer 26 preferably modify options associated with the custom house, for example, the heated square feet, the size of the garage, the number of bedrooms, bathrooms and location of master bedroom.

As noted above, although a prospective custom homebuyer 26 may elect to purchase a Division 1 house, features of Division 2 and Division 3 homes can be applied to modify the Division 1 house. After the standard plan has been modified to represent the custom home as desired by the custom homebuyer 26, the regional president 28 performs a financial analysis of the custom homebuyer 26 (step S204). After the regional president 28 determines that the prospective homebuyer qualifies for financing (step S206), then the regional president 28 operates the custom homebuilding management system 2 to create design parameters and translate the homebuyer's general ideas into a workable plan (step S208). As a preliminary requirement for the approval process, the regional president 28 ensures that the prospective custom homebuyer 26 authorizes a credit report release for analysis of the financial ability of the custom homebuyer 26 (step S210). At the conclusion of the sales meeting, the custom homebuilding management system 2 preferably outputs specifications, designs and cost estimates for use by the regional president 28, custom homebuyer 26 and regional operations officer 30 (step S212).

After the custom homebuilding contract is approved by the regional operations officer 30, information is transmitted to the custom homebuilding management system 2 for implementing the custom home project.

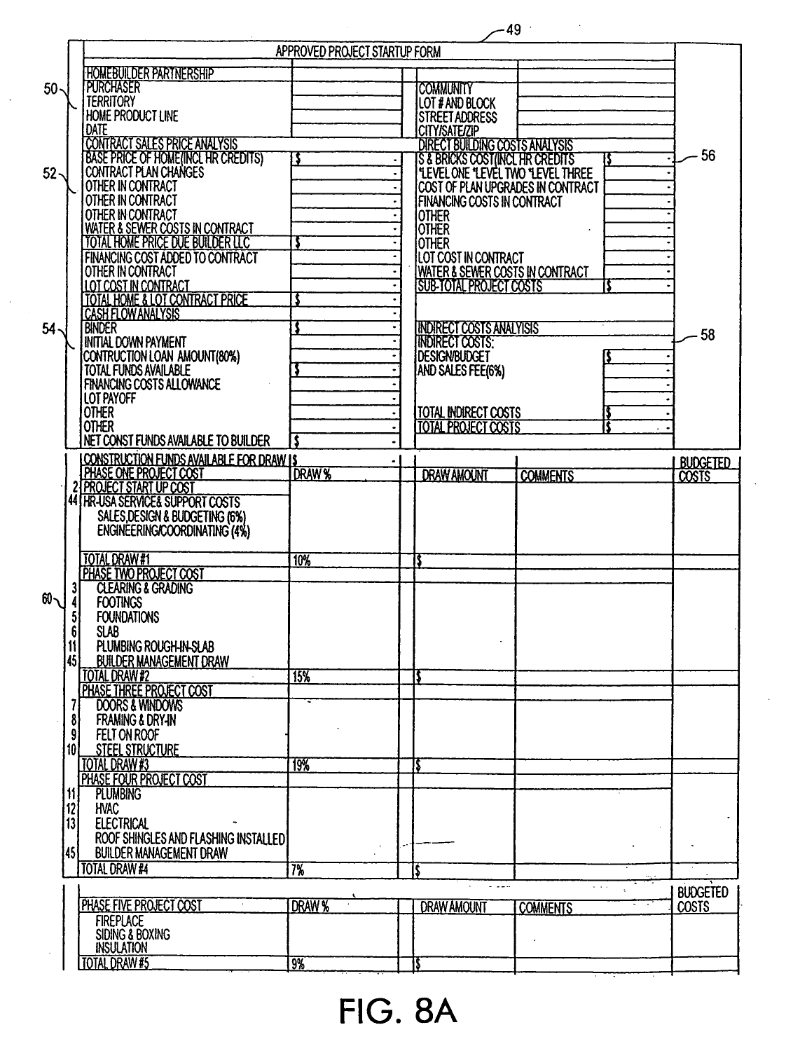

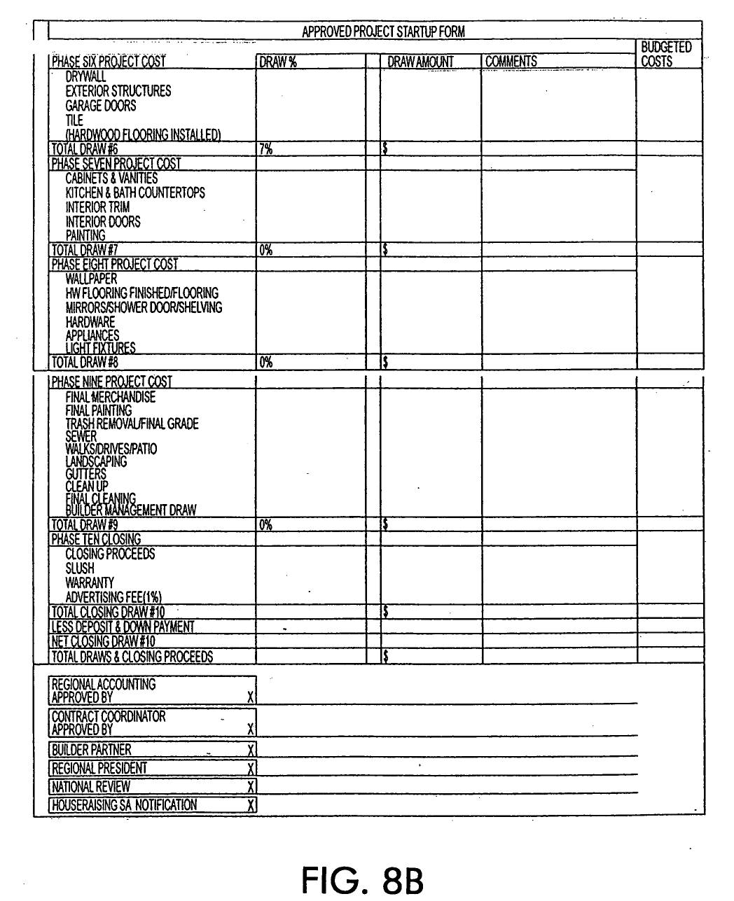

FIGS. 8A and 8B show an example approved project startup form 49 that is preferably used by the regional operations officer 30 after a custom homebuilding project is approved to begin implementing the custom home construction. As shown in FIGS. 8A and 8B, homebuilder information 50, contract estimates 52, cash flow 54, building costs 56 and indirect costs 58 are received by custom homebuilding management system 2. Moreover, budgetary allowances 60 are estimated for capital for materials and services that are used during the course of the custom home construction. The information entered data entry forms, such as the examples illustrated in FIGS. 8A and 8B, are preferably received by custom homebuilding management system 2 and processed to implement many of the processes described herein.

A plurality of parties contribute information that are entered into the approved project startup form 49 to provide estimates. For example, designers produce working drawings, specifications and budgets, including blueprints and contracts, to be entered into with preferred vendors 36 in order to assure that the values entered into the data entry form are accurate. If the approval process does not yield an accurate estimate of the total cost of completion of the custom home project, then losses will be incurred by one or more of the associated parties.

After the information is entered into the approved project startup form 49 shown in FIGS. 8A and 8B, the regional financial officer 32, the regional president 28, the regional operations officer 30 and the homebuilder 34 each preferably provide authorization on the approved project startup form 49. The authorization provided by the parties assures that, absent additional approved modifications, that the costs of the custom home will be unaltered.

In accordance with the present invention, capital funds are managed by the regional financial officer 32. Homebuilders 34 contractually agree to allow construction funds to be managed by the regional financial officer 32. By maintaining control over construction funds, the present invention ensures that funds are dispersed in appropriate amounts, to appropriate parties and in appropriate time frames. The present invention effectively removes the flow of funds as a tool for negotiation, and, further, ensures security by preventing misallocation and potential fraud. As shown in the construction phases section 60 of FIGS. 8A and 8B, funds are dispersed over a period of time, referred to herein as phases of a project. For example, during phase 1, costs related to service and support, sales, design, engineering and coordination are incurred. After phase 1 services are complete, then the first draw on the managed construction funds is made and payment for phase 1 services is made to the appropriate parties. In phase 2, (FIG. 8A), labor such as clearing and grading land, placing foundation footings, slab, and other construction labor is provided. Upon completion, payment for those services is made.

Phase 3 processes preferably include installation of doors and windows, framing, drywall installation, roofing, and other structural components. Phase 4 construction preferably includes plumbing, heating, ventilation and air conditioning (HVAC), electrical installations, roof shingles and flashings installation, and additional builder management costs. Phase 5 preferably comprises installation of fireplaces, siding and boxings, and insulation. Phase 6 preferably includes additional drywalling, installation of exterior structures, garage doors, tiling and hardwood floor installations. Phase 7 preferably comprises installation of cabinets, vanities, kitchen and bath countertops, interior trim, interior doors and painting. Phase 8 services preferably comprise wallpapering, finishing floors, installation of mirrors, shelving, hardware appliances and light fixtures. Phase 9 services preferably include final mechanicals, final paintings, finishing any sewer work, walkways, driveways or patios, landscaping, installation of gutters, and the final cleanup. Phase 10 typically comprises services related to closing. By dividing the services and materials for custom home construction into a series of phases, and allocating and drawing funds upon completion of each phase, a predictable and fair method of building fund allocation is assured to all parties.

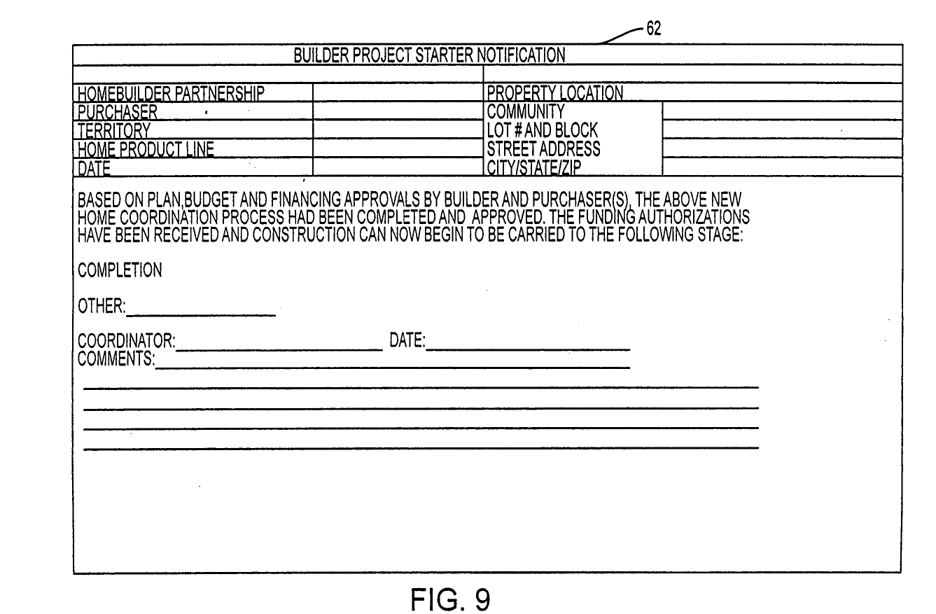

After the approved project startup form has been completed and authorized by the respective parties, a custom homebuilder 34 preferably receives notification by custom homebuilding management system 2 that the project has been authorized and the builder can begin the project. FIG. 9 shows an example builder project notification form 62 provided by the custom homebuilding system 2.

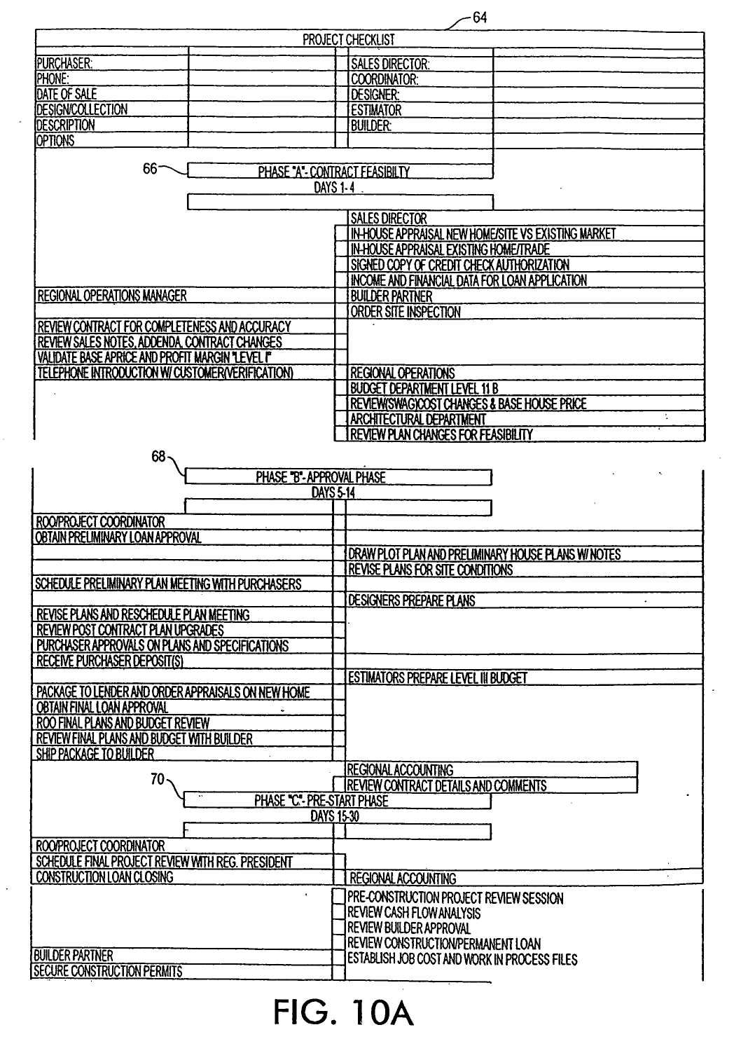

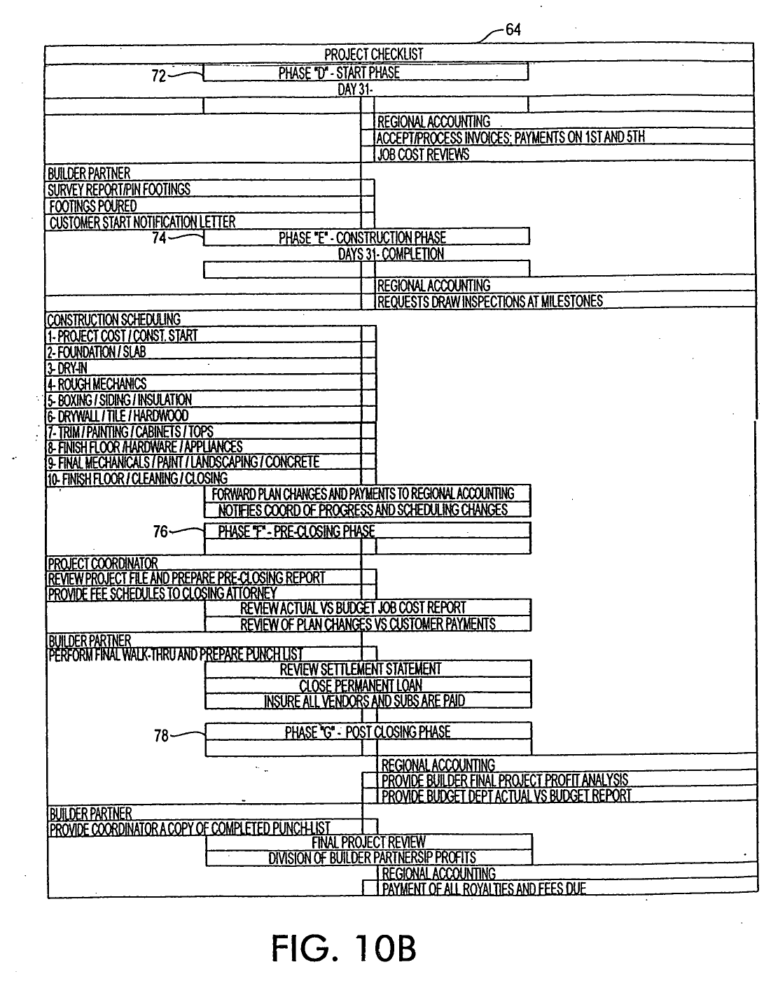

In addition to the builder project notification form 62 that is preferably automatically transmitted to the custom homebuilder 34 by the present invention, a project checklist 64, as shown in FIGS. 10A and 10B, is provided by the present invention. The project checklist 64 is preferably used to monitor the progress of a custom homebuilding project. The custom homebuilding management system 2 preferably receives and processes information received from the plurality of parties described herein, and provides an on-line resource that identifies the status of the new construction process. For example, and as shown in FIGS. 10A and 10B, the project checklist 64 indicates tasks and services to be scheduled and completed over the entire course of the project. As shown in FIG. 10A, the contract feasibility “Phase A” 66 identifies completion of sales negotiation tasks during the first days of the sales process (S102). “Phase B” 68 (FIG. 10A) identifies tasks and services to be scheduled and completed during the next nine days (days 5-14). The prestart phase “Phase C” 70 identifies tasks and services completed over the following two weeks (days 15-30).

The additional portions of the project checklist form 64 shown in FIG. 10B regard starting the project, construction, closing, and final review. This activity occurs after the first month of the project (day 31 to completion). For example, “Phase D” 72 comprises assembling construction teams, performing a survey, pouring footings and notifying the custom homebuyer 26 of the beginning of construction. In construction “Phase E” 72, the ten phases described above with respect to the disbursement of funds are identified to determine whether or not each phase has been completed. In the pre-closing phase “Phase F” 76 of the project checklist form 64, a pre-closing report is generated by the present invention, and fee schedules are preferably given to the homebuyer's closing attorney. Moreover, the final walkthrough and a “punch list” (described in detail below) is prepared. In the post-closing phase “Phase G” 78 and final review, the custom homebuilding system 2 provides project profit and loss analysis, a report showing actual versus estimated costs, and a completed punch list in accordance with the present invention. The project checklist 64 is also preferably used by the present invention to generate an automatic notification to the parties associated with custom homebuilding. For example, if a scheduled task is not completed and, therefore, no corresponding indication of completion is made on the project checklist form 64, the present invention automatically generates a notification, such as an e-mail message, to the responsible party that a scheduled task is not complete. Further, the present invention preferably uses information received by the operators thereof to provide advance notice to the parties associated with the custom homebuilding project of pending dates and schedules. In this way, schedules can be maintained and communication is improved thereby lessening the likelihood of interruption of a new homebuilding construction schedule.

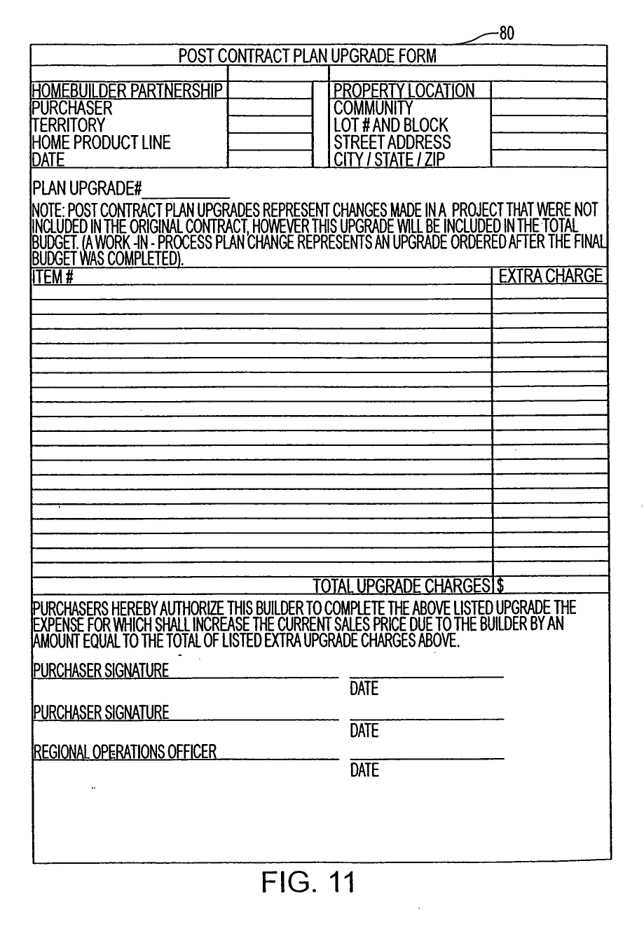

During the course of new construction home project, approved changes and modifications may occur that were not included in the original contract but must be included in the final budget. For example, a carpet plan change represents an upgrade that was ordered by the custom homebuyer 26 after the final budget was completed. In such case, the present invention preferably receives information and provides notification, such as the post-contract plan upgrade form 80 (FIG. 11) that identifies the specific upgrade and any other additional charges that incur as a result. The form preferably requires authorization by the custom homebuyer 26 and the regional operations officer 30 in order for the changes listed therein to be approved.

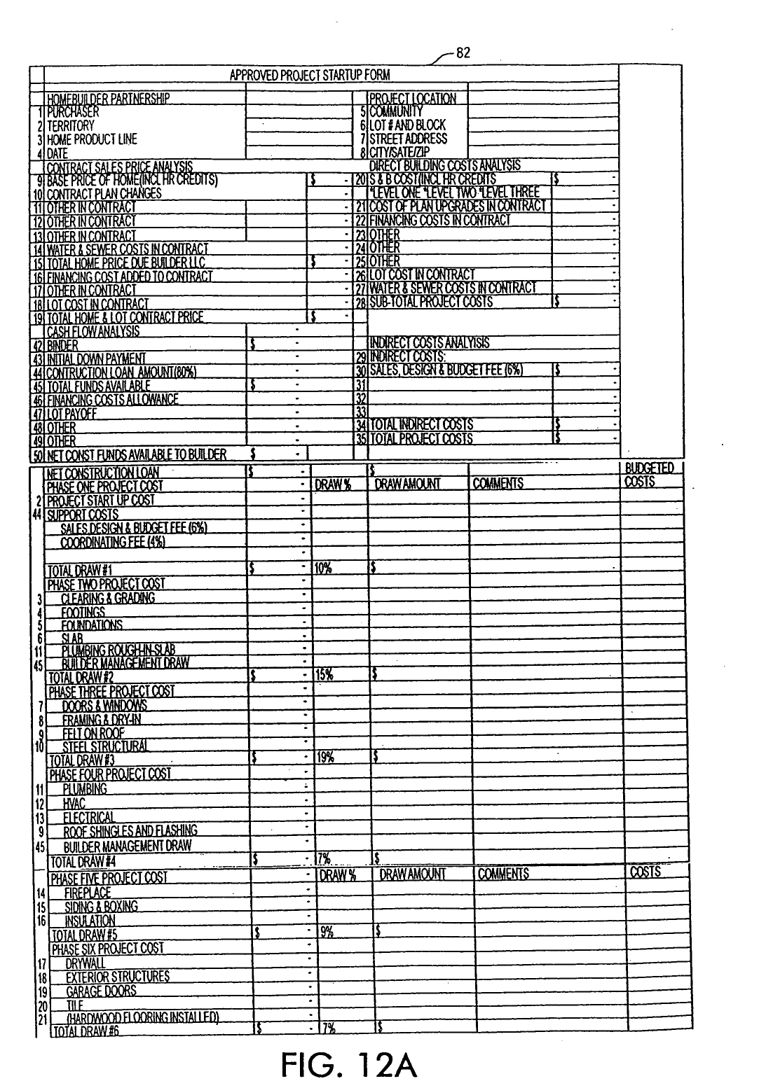

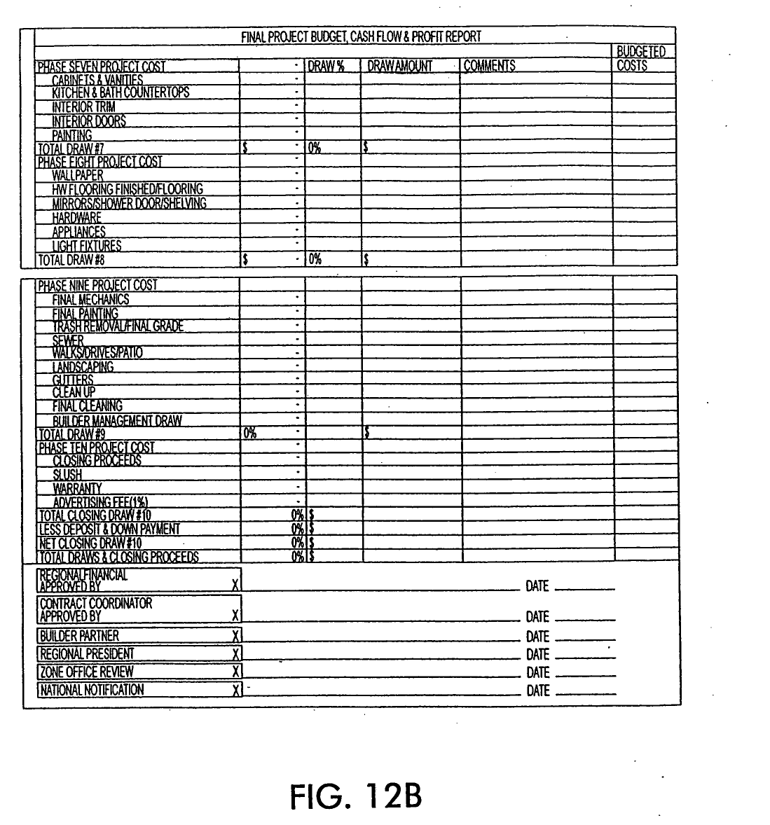

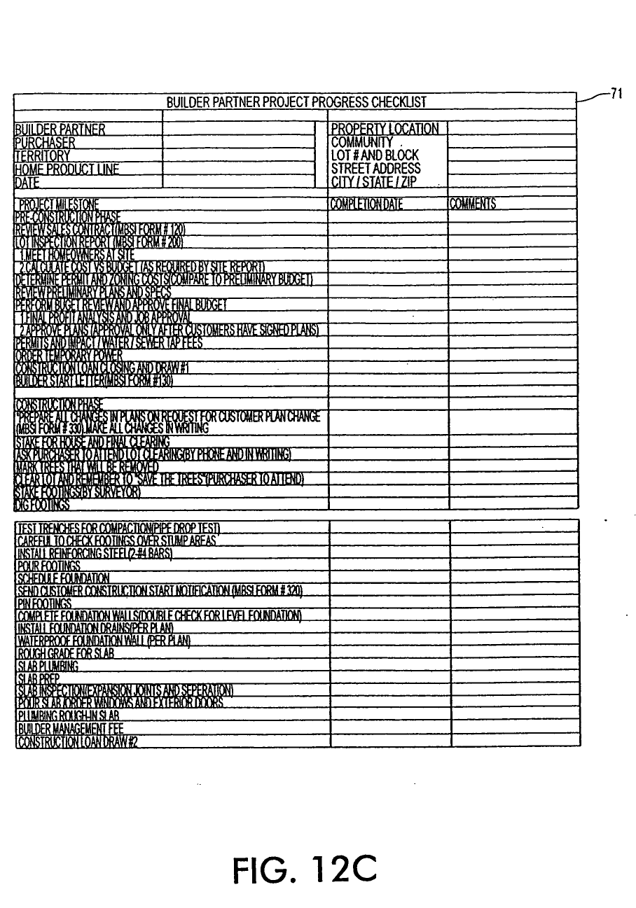

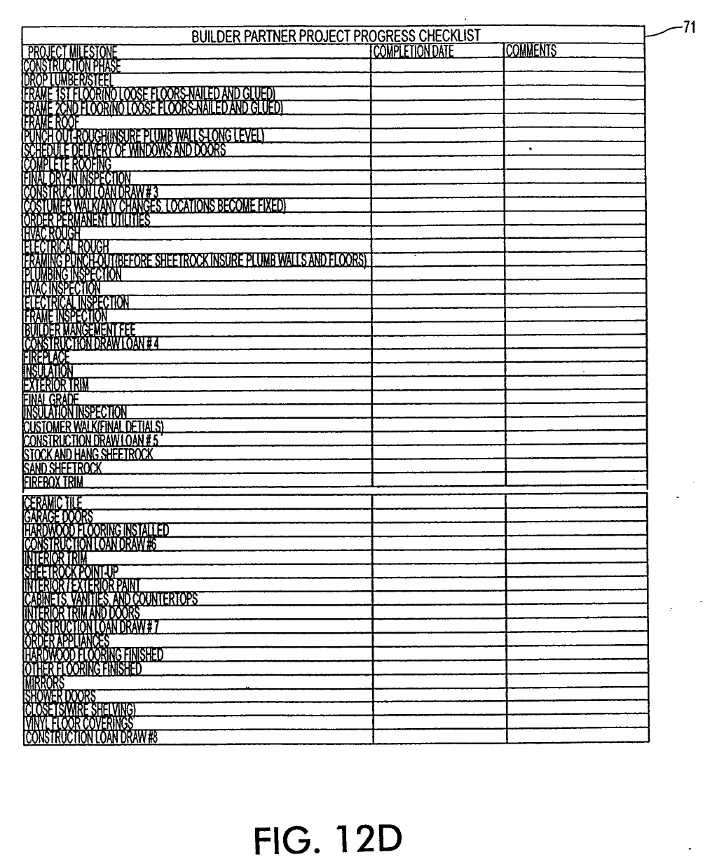

FIGS. 12A and 12B identify a final project budget, cash flow and profit report 82 that is preferably generated automatically by the present invention after completion of the ten phases of construction described above with respect to disbursement of construction funds.

The final project budget, cash flow and profit report 82 identify the actual amounts that are dispersed during the course of the new construction homebuilding project. As shown in FIG. 12A, the base price of the home is provided with modifications made to the standard plan and additional costs that were applied during the initial site inspection. Further, the additional costs added to the contract, for example, financing costs, are preferably entered into the custom homebuilding management system 2 and identified in the final project budget, cash flow and profit report 82, as shown in FIG. 12A. Other information including the amount of the binder, downpayment and construction loan amount is displayed, along with indirect costs such as sales, design and budget fees, financing costs and the like. Moreover, details directed to funds that are drawn by the present invention in order to remunerate builders for labor and materials during the ten phases of construction (described above) are provided in the final project budget, cash flow and profit report 82.

The custom homebuilding management system 2 preferably performs an analysis of the amount that was budgeted for the ten phases of construction with the amount that was actually dispersed. Percentages of profit and loss are preferably provided, and used to identify whether or not the custom homebuilding project was ultimately profitable.

In a preferred embodiment, the values that are identified in the report 82 can be modified by authorized personnel, for example, the regional financial officer 32. For example, while viewing the report 82 on a computer display, the regional financial officer selects a graphic control, for example, a button, and a data entry form is preferably provided to modify some of the values that are displayed in the report 82. Preferably, the custom homebuilding management system 2 recognizes the level of authority granted to the regional financial officer 32 when the regional financial officer 32 establishes an on-line session with the present invention. Parties that are unauthorized to make modifications to values in the database associated with the present invention are restricted for modifying any information.

The final project budget cash flow and profit report 82, as illustrated in FIGS. 12A and 12B, is a very useful compilation of information that is processed by the present invention in order to ensure that parties stay on budget, and that estimates are accurate. During and after completion of a custom homebuilding project, information is stored by custom homebuilding management system 2 and used to modify previous entries and keep data in the database current. For example, if the final project budget cash flow and profit report 82 indicates a loss, then the present invention preferably performs an analysis on the values therein to identify the particular cause and source of loss and, further, to prevent the loss from recurring. For example, the cost of grading a particularly steep slope that has very wet soil may have been estimated too low, thereby causing problems in the budget throughout the course of a custom home project. In accordance with the present invention, future cost estimates for grading land that has a steep slope and having wet soil will be, thereafter, adjusted. In this way, a system of checks and balances constantly occurs and the present invention serves to improve estimates and profitability of future new constructions.

In addition to the project checklist 64, custom homebuilders 34 preferably provide information in similar respective project checklists. FIGS. 12C and 12D illustrate a sample builder project progress checklist 71 that is preferably available via an Internet web page. In the example shown in FIG. 12C, a series of completion dates and comments are provided by the custom homebuilder 34 during the pre-construction and construction stages of the custom homebuilding project. As shown in FIGS. 12C and 12D, a plurality of jobs that are required to be completed during the construction are identified. For example, during the construction phase, the builder 34 indicates when the lot was cleared, when stake footings and dig footings were placed, when reinforcement of the footings were poured, and the like. The present invention preferably uses the information received in the builder project progress checklist 71 in order to notify the regional operations officer 30 and the homebuyer 26 of completion or the pendency of jobs during the course of the new construction.

As described above, the present invention preferably identifies when specific tasks are either upcoming or overdue, and provides automatic notification, for example, e-mail notifications, of the pendency of particular jobs. Specific time schedules are preferably programmed into the system to indicate acceptable and unacceptable times during a custom construction. For example, the system 2 receives information from the homebuilder 34 that an electrical system was installed on March 1^{st} and the system, determining that the date is April 1^{st}, prompts the regional operations officer 30 that no inspection of the electrical system has been performed. A plurality of notification strategies are available in accordance with the present invention, for example, by sending a message after one week of installation of the electrical system to the regional operations officer, and a notification to the regional president 28 after one month of completion of the electrical system if the inspection of the electrical system has still not occurred.

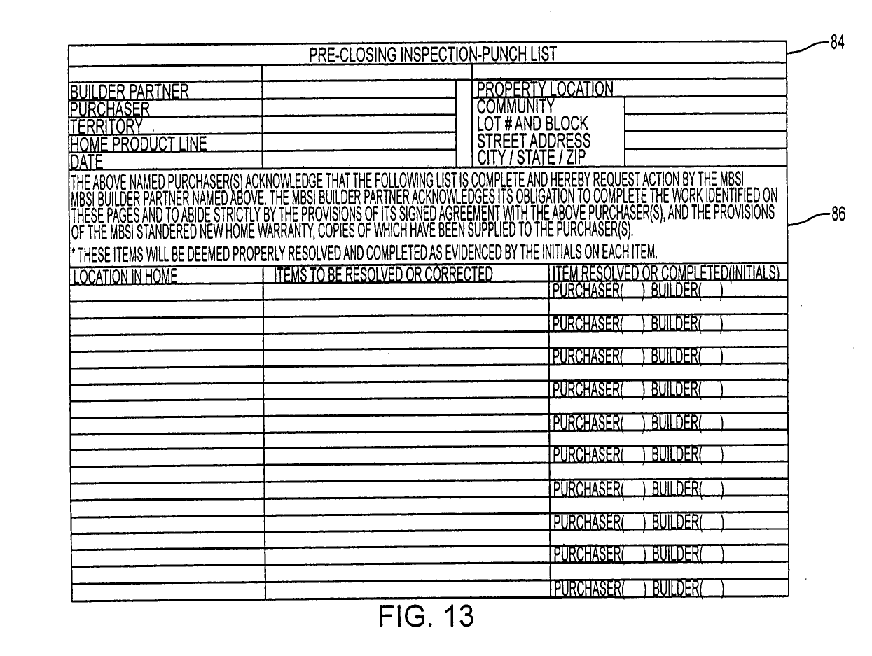

The present invention preferably provides for a pre-closing inspection report, referred to herein as a “punch list” 84 as shown in FIG. 13. The punch list 84 identifies items or labor that require completion or resolution even though the new construction is ready for occupancy. The invention preferably provides instructions for the parties how punch lists 84 are prepared, approved and completed.

As shown in FIG. 13, the punch list 84 identifies the custom homebuyer 26 and the respective homebuilder 34 involved in the new construction. As shown in text area 86 of the punch list 84, the homebuyer 26 expressly acknowledges that the list of items to be resolved or corrected is complete. Moreover, text area 86 identifies that the homebuilder 34 recognizes its obligation to complete the work identified on the punch list 84. By expressly providing that the list of items on the punch list 84 is complete, and that an obligation exists to complete the work identified in the list, then the custom homebuyer 26 is assured that the work will be completed and the homebuilder 34 is assured that they will be renumerated for completion of the project. As noted above, a common conflict that occurs in the prior art with respect to custom homebuilding regards completion of final tasks of a new construction.

After the items identified in punch list 84 require completion and the parties provide authorization to the custom home building management system 2 regarding approval of the list, the punch list 84 is preferably printed and used as an appendix for referral in the closing contract. Therefore, at the time of closing, a provision is made that refers directly to punch list 84, and requires the homebuilder 34 to complete the tasks identified therein in order to receive funding.

As noted above, financing and monitoring progress of the designing and building of a custom home is controlled by the terms of the present invention. As noted above, the construction time-table is preferably divided into ten phases and the regional financial officer 32 coordinates the budget with a construction loan draw schedule to control draws on capital in accordance with the custom home building project's progress.

In a preferred embodiment of the present invention, capital funds are controlled in four components: access to the available money, submission and verification of withdrawals, disbursement, and job cost and audit control.

The present invention preferably establishes the right to access and disperse funds. This is accomplished by a contractual relationship between the parties at the start of the custom home building project. The custom homebuilder 34 and the custom homebuyer 26 agree that funds will be managed by the regional financial officer in accordance with the present invention. Moreover, a construction loan agreement with the mortgage company 37 preferably includes at least one clause that provides the authority to request and disperse loan proceeds with the regional financial officer 32.

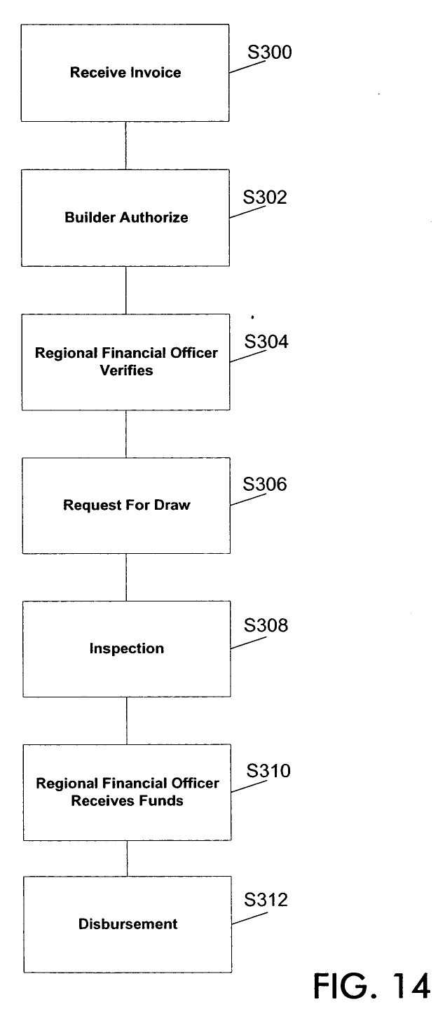

In addition to access to the funds, the control of funds directed to submission and verification of withdrawals is preferably performed in a series of steps. FIG. 14 is a flow chart showing example steps comprising the submission and verification component of capital funds control in accordance with the present invention. As shown in FIG. 14, in step S300 an invoice is received from a preferred vendor 26. Preferably, the custom homebuilder 34 is required to verify that the invoice received is accurate and, further, that the builder provide authorization in the custom home building management system 2 for each invoice received over (step S302).

The present invention preferably processes the information received from the custom homebuilder 34 and provides the authorization of the respective invoice to the financial officer using a series of display screens on an Internet website. After the regional financial officer 32 has confirmed that a received invoice is accurate and authorized by builder 34, the regional financial officer 32 preferably verifies the accuracy of the received invoice (step S304). This is accomplished, in part, by comparing the receipt invoice with amounts that were budgeted during the sales and approval processes (step S102 and S104, respectively, FIG. 6). Any variances between actual invoices and budgeted amounts are preferably documented in the custom home building management system 2 and processed thereby.

After invoices have been received, authorized by the builder 34 and verified by the financial officer 32, they are saved until completion of the respective construction phase to which they belong. For example, invoices directed to moldings, painting, cabinets and tops (building phase 7, FIG. 8B) the regional financial officer 32 submits a request for a draw on the capital funds to the regional mortgage company 37 that is providing the construction loan. In this way, payments are drawn on the capital funds after completion of services, and with respect to completion of construction phases as described herein.

In accordance with the present invention, after the regional mortgage company 37 receives the request for a draw on the capital funds, a regional mortgage company 37 preferably performs an inspection of the labor and materials that are represented in the respective invoice (step S308). Alternatively, the regional operations officer 30, or other party, performs an inspection and submits details of the inspection, via the present invention, to the regional mortgage company 37. In the event that a conflict or question arises during the inspection, then the submission and verification group preferably reconciles the conflict or question, prior to the funds being drawn.

After the regional mortgage company 37 authorizes payment on the invoice, the appropriate funds are drawn and provided to the regional financial officer 32 who controls the funds in accordance with the present invention (step S310). Thereafter, in step S312, the submission and verification group passes the completed draw request with the corresponding invoices to a disbursement group. Preferably, the disbursement group comprises the regional financial officer 32 and associated staff.

The disbursement group is responsible for delivering funds to the appropriate parties in the amounts determined during the above identified processes (step S300-S312). The disbursement group preferably receives the request for disbursement from the submission and verification group and the amounts and payees are preferably verified by the disbursement group prior to disbursement of any capital funds. The disbursement group further generates transfers or checks in the appropriate amounts and to the appropriate individuals.

In accordance with the present invention, the receipt of the funds are entered into the custom home building management system 2 and verified by the disbursement group. Moreover, the present invention preferably notifies the submission and verification group that these funds have been released. In a preferred embodiment of the present invention audits are conducted of both the submission and verification group and the disbursement group both on a scheduled and random time basis in order to verify that procedures are being followed and that the results are correct. The auditing preferably checks the seven procedural steps described above (step S300 through step S312), and further that the disbursement processes described above are properly followed. Preferably, the parties performing auditing functions operate with some independence to ensure accuracy and objectivity. Also, the custom home building management system 2 preferably determines specific dates for audits, and provides notification to the party performing the audit of the scheduled dates.

As noted above, present invention preferably enables the custom homebuilders 34 and the regional officers (regional president 28, operations officer 30 and regional financial officer 32) to operate concurrently during a custom homebuilding project. For example, while a builder 34 is involved in a construction phase 2 of a project (FIG. 8A), the regional financial officer is working to approve an invoice that was received with respect to phase 1 of the project. Even though the parties operate concurrently, the present invention provides systematic and substantially real time management of all of the parties.

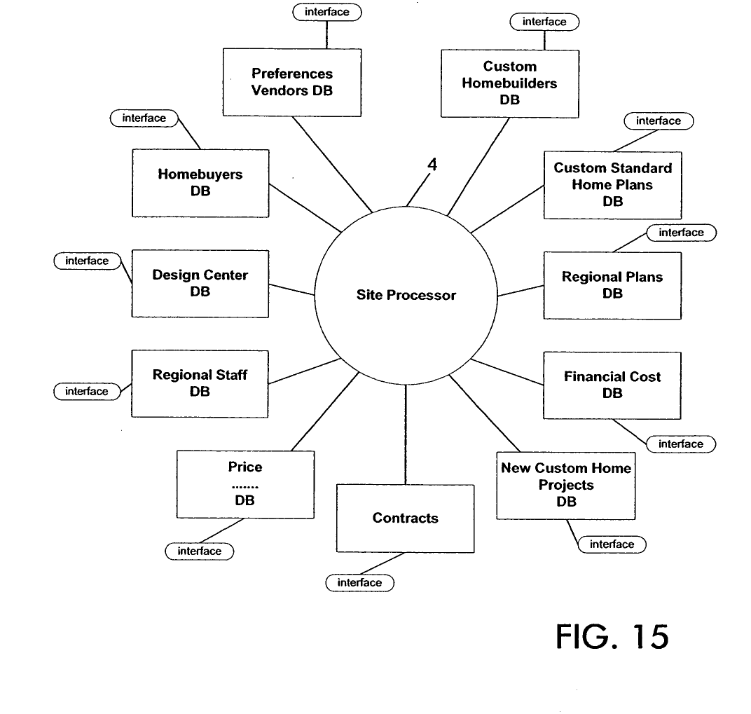

FIG. 15 is a black box diagram that identifies a plurality of databases and user interfaces for providing much of the functionality described herein, and illustrates one embodiment of databases and user interfaces in accordance with the present invention. As shown in FIG. 15, a plurality of databases, denoted as “DB,” represent specific features and elements of the present invention. A plurality of user interfaces, preferably operating on Internet web sites, are also illustrated in FIG. 15 and represent interfaces for the various ways that parties using the present invention can operate. Of course, one skilled in the art of writing computer executable code will recognize that many different database and interfaces can be developed to afford the functionality described herein.

Although, as shown in FIG. 15, each database has a corresponding interface it is evidenced herein that one database may have a plurality of user interfaces, and one user interface may relate to a plurality of databases. The interface represents a way for users operating the custom homebuilding management system 2 to submit and retrieve information directed to the respective database. Although each database has an interface that corresponds to it, use of any one interface may not be necessary in order for the present invention to function correctly. For example, an interface that the mortgage company 37 uses to submit information regarding new homebuilding construction loans would not necessarily be used by the regional financial officer 32 to request a draw on capital funds in order to pay an invoice. The information directed to releasing funds to pay the invoice may be stored in a financial database, but the interface that is operated by the regional financial officer 32 may relate to preferred vendors 36.

It is envisioned herein that interfaces enabling users to operate custom homebuilding management system 2 provide one or more display screens and data entry forms. Moreover, screen controls and access to various interfaces is preferably restricted to authorized users. The interfaces and corresponding databases are used and applied in many different contexts depending upon the task at hand. For example, when a regional president 28 and a perspective custom homebuyer 26 meet to design a custom home, information may be retrieved from a plurality of databases to produce the desired end result.

Examples of databases and user interfaces shown in FIG. 15 are as follows: a custom standards and home plans database; a financial costs database; a contracts database; a price matrices database; a custom home project database; a homebuyer database; a preferred vendors database and custom homebuilders database. These databases may be referenced individually or in combination to supply and receive information, for example, during the sales meeting between the regional president 28 and a prospective custom homebuyer 26. The interfaces and databases operate to receive, process, and transmit custom homebuilding information for the purposes of managing parties associated with custom homebuilding.

After a new home construction is complete, the regional president 28 preferably uses the system 2 to evaluate the completed home, the quality of materials and specifications, and to evaluate the skills and development progress of a homebuilder 34. Preferably, the custom homebuilding management system 2 prompts the regional president 28 to respond to a series of questions and controls. The responses the regional president 28 makes to the prompts regard rating specific features of the new homebuilding project.

For example, the regional president 28 identifies the skill set of the homebuilder 34 (ranking of A through E, depending upon whether the homebuilder 34 possesses excellent homebuilding skills, good workman-like skills, was tough and fair but not friendly, whether the homebuilder displayed a lack of supervisory skills or whether the homebuilder simply did not build a quality home, respectively). Other information provided by the regional president 28 regards the communication skills of the homebuilder, whether the project was completed on budget, whether plan changes were handled and whether the punch list 84 was adequately produced.

The regional president 28 also provides a numeric rating of whether the overall construction quality was excellent, very good, comparable and acceptable, careless, negligent or, in the worst case, totally unacceptable. More particularly and in a preferred embodiment, the regional president 28 rates specific areas of the custom home. For example, the regional president 28 rates the driveway, including, for example, the driveway entrance, the sidewalk slope, any turnaround area, and the “tie-in” to surrounding landscape, and the overall cleanup of the project waste and leftover materials. Further, the regional president 28 rates the general condition of the finished landscape including, for example, rating whether proper drainage areas were prepared and seeded to specifications, whether the lawn area was finished, whether the shrubbery was to specification, whether there is elevated bedding or pine straw covering and whether there are downspouts in adequate roof drainage ways. Further, the regional president 28 rates the condition and appearance of porches and patios, including, for example, appearance of entry sills, jambs and headers, whether there is a sloped porch or patio floor, the quality of the general floor finish, whether columns are aligned and whether the porch beam construction is acceptable. Further, the regional president 28 rates the appearance and condition of the roof, for example, the condition of the ridge, rate, trim and finish, whether head joints are properly aligned, whether there is proper flashings, and whether pluming vent pipes are painted to blend with shingles. Further, insulation of windows, screens and blinds are rated, and the quality of sighting spots and trim is rated.

Also during the rating process, the regional president 28 preferably rates the garage area, including, for example, whether the doors are a proper fit and finished, whether the doors are installed to protect the garage from bad weather, and whether the concrete floor is smooth sealed and clean. Further, the regional president 28 preferably rates the installation of the entry doors including the front doors, whether they are properly painted, their hardware is functioning properly, whether a deadbolt is installed and functioning properly, whether a brass kick plate is properly installed, whether a door knocker is installed and whether the doorbell is installed and functioning. Moreover, all other exterior doors are rated to determine whether they are properly painted, whether the hardware is functioning correctly and whether deadbolts are installed and functioning properly.

Also during the rating of specific areas of the new construction, the regional president 28 preferably rates the appearance of the entry foyer in terms of the general appearance, the design features, the stairway and stair parts and whether the finishing of the floors and walls and appearance of other doorways to living areas is acceptable. Further, the regional president 28 preferably rates the appearance of the kitchen, including, for example, the general appearance of the kitchen layout, cabinets, appliances, flooring and pantry.

Also included in the rating of the specific areas in the new construction, the regional present 28 preferably rates the appearance of living areas, including the general appearance flooring base and window trims thereof. The master bath is also rated in terms of its design, the plumbing specifications and the qualities of the materials and labor. Further, the master closet and other closets are rated in terms of whether they have adequate storage, and the quality of the materials and labor. The regional president 28 also preferably rates the attic, to determine for example, the quality of the plywood floored area for storage, whether the attic is neat and has clean breezing, whether there is a pull down or adequate stairway access, and whether there is a light that is installed in the attic. Further, the regional president 28 preferably rates the appearance of interior walls and ceilings to report the quality of the sheetrock finish, to whether the walls are sanded and painted, and whether the wood trim is sanded and nail holes are filled and properly painted. Additionally, the regional president 28 rates the general flooring condition to determine whether there are squeaks or any areas that are not level and the overall general appearance and quality of materials and insulation of the floors. Additionally, the regional president 28 preferably determines the quality of the interior cleaning, including for example, whether the windows are clean and operational, whether the tracts are cleaned, whether the cabinets are cleaned, whether the floors are cleaned and whether the general house appearance has adequately been kept up.

The information that is retrieved from the home inspection report and provided by the regional president 28 is used by the present invention to evaluate the labor and materials used to contribute to the construction of custom homes. For example the present invention identifies three custom homebuilding projects that suffered from uneven garage doors. The garage doors were installed by the same vendor in each of the three cases. The present invention preferably uses the information to provide a notification to the regional president 28, or to other regional officers, regarding details of the substandard work. The information received during the course of the custom homebuilding project and upon completion thereof, is preferably used by the present invention to update information already stored therein regarding the respective vendors 36, builders 34 and materials that are used in the new constructions.

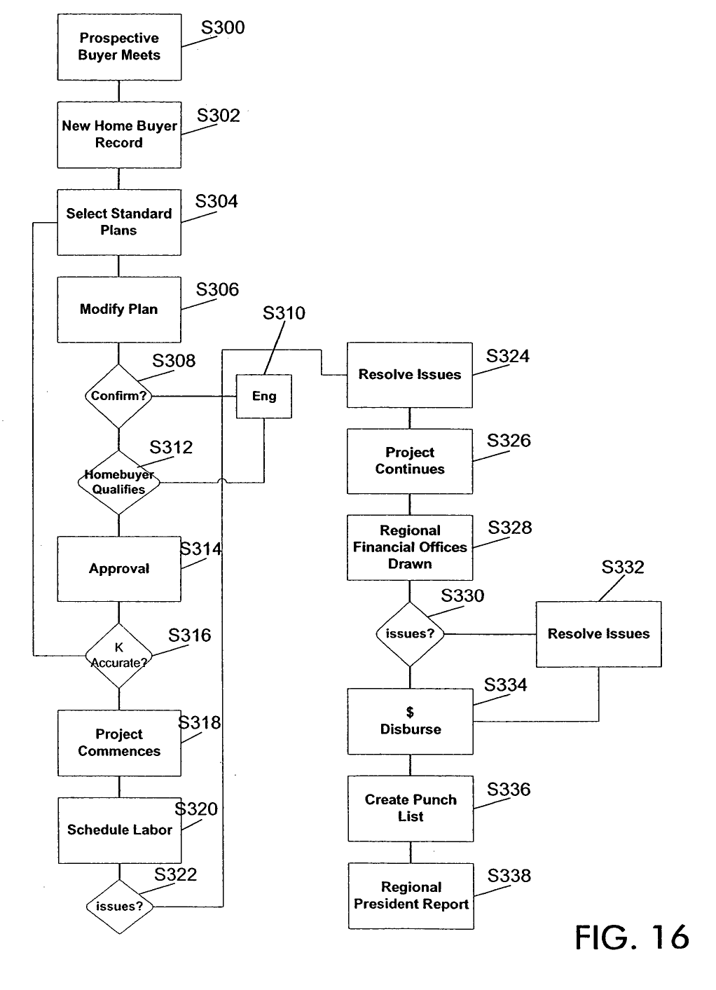

FIG. 16 shows a flow chart that represents an overview of the processes described herein with particular focus on the custom homebuyer 26. In step S300, a prospective homebuyer agrees to meet with the regional president 28 for the purposes of contracting to have a custom designed home built. In step S302, a new homebuyer record is added to the homebuyer database (FIG. 15). Thereafter, the prospective custom homebuyer 26 and regional president 28 operate the present invention to review standard home plans available in the standard home plans database (step S304). After a standard plan is selected, modifications are made to the standard plan by the regional president 28 and prospective custom homebuyer 26 in order to implement desired characteristics and features of the custom home (step S306). The prospective custom homebuyer 26 and the regional president 28 agree on a design plan for the home, and a determination is made whether the prospective custom homebuyer 26 desires to enter into a contract (step S308). If the prospective custom homebuyer does not wish to continue, the process ends (step S310). If, however, the custom homebuyer 26 wishes to proceed with a contract, then the regional president 28 performs a financial analysis on the prospective buyer 26 to determine whether or not the prospective buyer can qualify for a loan amount required to purchase the new open home (step S312). If the customer does not qualify, then the process ends (step S310). If the customer does qualify, then the regional president 28 uses the present invention to automatically generate a contract that is to be entered into between the prospective custom homebuyer 26 and the franchise or other company that operates the present invention.

Thereafter, in step S314, the regional operations officer 30 begins the approval process. The contract is reviewed in step S316 to determine whether it accurately portrays and estimates the cost of building the custom home. In the event the contract is not accurate, then the process reverts back to step S304 and the regional president 28 and the prospective custom homebuyer 26 meet again to make necessary revisions. In the event the contract is accurate then the process continues and the project commences (step S318).

In step S320, the regional operations officer 30 preferably proceeds to assemble project resources including, for example, the pre-arranged preferred vendors 36 that are also parties to the invention and the builder 34 (step S320). During the new home construction, there are determinations that are made throughout the process whether any issues need resolution (step S322). In the event that issues require resolution, then the process moves to step S324 and the issues are resolved. After outstanding issues are resolved, the workflow processes associated with constructing the custom home continue (step S326). In the event that no issues are encountered in step S322, then the process flows directly to step S326.

Upon successful execution of the new building project, then control is passed to the regional financial officer in step S328. As described above with respect to the financial management of funds, as the ten phases of the construction (FIG. 8A) are completed, the regional financial officer 32 operating in conjunction with the regional operations officer 30 and the regional mortgage company 37 proceed to disperse funds. During the disbursement of funds, analyses are made whether any issues exist that would preclude funds from being drawn (step S330). In the event that there are issues, then the process flows to step S332 and the respective issues are resolved. From step S332, the process continues to step S334, and money is dispersed and the workflow processes continue. If no issues were determined to exist in step S330, then the process flows directly to step S334. Upon completion of the project, a punch list 84 is generated, in step S336, and any remaining uncompleted tasks are identified, completed and the regional president 28 performs his review (step S338). In this way, the present invention efficiently manages the process for custom homebuyers 26 of designing and purchasing a custom home.

Thus, in accordance with the processes and descriptions herein, the present invention offers custom homebuyers 26, homebuilders 34 and vendors 36 and opportunity to utilize a central management system to design and build unique homes. In a preferred embodiment, the present invention can be distributed to a franchise, or offered to regional companies operating in geographic areas where 10,000 residential building permits are issued annually, thereby comprising a region. Custom homebuyers 26, homebuilders 34 and preferred vendors 36 use the present invention as a management tool to define, organize, support and monitor activities of the parties involved during the designing and building of custom homes.

Moreover, the present invention preferably operates to increase the quality of custom designed homes while simultaneously reducing overhead costs by organizing the participants efficiently, and reducing direct costs of designing and building the homes. By agreeing to the terms and conditions provided by the present invention, the parties associated with custom homebuilding insure the custom homebuyers 26 will receive expert assistance while developing unique home plans and will benefit by developing homes at lower costs. By committing to utilizing the invention, custom homebuyers 26 benefit by receiving high quality custom homes in an organized and controlled environment.

The present invention maintains current and accurate data by receiving information during the course of a custom homebuilding project. By maintaining the present invention on one or more Internet web site(s), and receiving information from the plurality of parties associated with custom homebuilding, information that is erroneous is replaced with more current and accurate information.

The present invention further provides builders 34 with methods of operation that allow them to earn reasonable and predictable profiles while alleviating them from many management related issues occurring in the prior art. The present invention also develops ongoing relationships with preferred vendors 36 such that small vendors 36 can operate with lower overhead costs while receiving fair profits for their projects and services. Further, timely payments of invoices are assured by the present invention. The present invention was created to provide custom homebuyers 26, homebuilders 34 and vendors 36 an organized methodology that can be utilized to design and build custom homes with minimal conflict and maximized value.

The present invention provides a dependable mechanism to organize and manage the process of designing and building custom home projects such that the projects are accurately priced prior to commencement of construction. Moreover, by providing clear organization of the parties, overhead costs are reduced such that the total cost of the projects are significantly reduced, for example, by 15%. Further, the present invention provides predictability in the design/build process for all involved. The invention comprises a business management methodology electronically administered through Internet based software.

Although the present invention has been described in relation to particular embodiments thereof, many other variations and modifications and other uses will become apparent to those skilled in the art. Therefore, the present invention is not limited by the specific disclosure.

What is claimed is:

1. A method for predicting the cost of labor and materials for custom building construction, said method comprising:
storing first electronic construction information related to construction projects in a database;
storing second electronic construction information related to construction features for said construction projects in said database;
retrieving first electronic construction information related to one of said construction projects from said database;
retrieving second electronic construction information related to at least one construction feature from said database; and
applying said second electronic construction information retrieved from said database to said first electronic construction information using an algorithm retrieved from said database which applies costs related to labor and materials for building a construction project according to said first and second electronic construction information to generate electronic first modified construction information representing a first construction project, wherein said first modified construction information includes characteristics related to costs associated with labor and materials used for said first construction project, such that the actual cost of labor and materials after completing said first construction project is the same as the predicted cost of said first construction project.

2. The method of claim 1, further comprising storing third electronic construction information in said database related to labor for building said construction project and for building or providing said construction features.

3. The method of claim 2, wherein said step of generating said first electronic construction information includes retrieving said third electronic construction information from said database and using said algorithm to apply said third electronic construction information retrieved from said database to generate said first electronic construction information.

4. The method of claim 1, further comprising storing fourth electronic construction information in said database related to materials for said construction project and for said construction features.

5. The method of claim 4, wherein said step of generating said first electronic construction information includes retrieving said fourth electronic construction information from said database and using said algorithm to apply said fourth electronic construction information retrieved from said database to generate said first electronic construction information.

6. The method of claim 1, wherein said electronic first modified construction information is generated prior to building said first construction project.

7. The method of claim 1, further comprising storing fifth electronic construction information in said database related to services provided by vendors associated with building said first construction project.

8. The method of claim 7, wherein said vendors of services include at least one of accountants, lawyers, plumbers, tile workers, electricians, painters, and masons.

9. The method of claim 1, wherein said step of retrieving comprises a user selecting said first and said second electronic construction information.

10. The method of claim 1, wherein said construction project is a house.

11. A method for managing parties contributing to a construction project, said method comprising:
selecting a construction design from a plurality of construction designs stored in a database;
modifying said construction design to generate a modified construction design, said modified construction design representing said construction project;
using an algorithm to apply costs related to labor and materials for building said constructions characterized by said plurality of construction designs to generate a prediction of costs associated with building said construction project;
identifying at least one provider of at least one of labor and materials for said construction project, and contractually committing said at least one provider to said construction project;
defining at least one construction phase for building said construction project, said at least one construction phase representing at least one of a series of tasks to be completed and materials to be provided by said at least one provider in a predefined order;
applying another algorithm to generate a construction schedule in connection with at least one of said construction phases for said at least one provider;
receiving an invoice for at least one of provided labor and materials from said at least one provider; and
remunerating payment to said at least one provider after completion of a respective construction phase and after determining said at least one of provided labor and provided materials in said invoice has been adequately provided.

12. The method of claim 11, further comprising electronically notifying said at least one provider of said construction schedule.

13. The method of claim 11, further comprising obtaining and holding said payment prior to said step of remunerating.

14. The method of claim 11, further comprising training said at least one provider according to rules directed to at least one of labor, materials and construction processes.

15. The method of claim 14, wherein the rules comprise at least one of ensuring a foundation is level prior to framing a structure, preparing a homebuyer for a change in appearance of a building lot after the lot is cleared, and ensuring that no liens are placed on the custom homebuilding project.

16. The method of claim 14, wherein said rules are selected such that adherence to said rules enables accurate prediction of costs associated with building said construction project.

17. The method of claim 11, further comprising accurately predicting costs associated with building said construction project.

18. The method of claim 11, further comprising storing provider information including characteristics related to said at least one provider in said database.

19. The method of claim 18, wherein said step of identifying said provider comprises selecting from said provider information.

20. The method of claim 18, wherein said step of identifying said provider comprises applying an algorithm to electronically select from said provider information.

21. The method of claim 18, wherein said provider information includes at least one of a name, labor cost, materials cost, services, location and contact information.

22. The method of claim 11, wherein said construction project is a house.

23. A method for selling a construction design and construction project to a buyer, said method comprising:
retrieving first electronic construction information representing a first construction project from said database;
retrieving second electronic construction information representing at least one construction feature from said database;
applying a first algorithm to generate an estimate at least one of an amount of labor, a cost of labor, an amount of materials and a cost of materials for building a first modified construction project characterized by a combination of said first electronic construction information and said second electronic construction information;
applying said first algorithm to retrieve said estimate substantially automatically from said database;
applying a second algorithm to generate a contract for sale of said first modified construction project from stored contractual provisions and said first and second electronic construction information;
applying said second algorithm to retrieve said contract substantially automatically from said database; and
completing an approval process to determine whether to execute said contract.

23. The method of claim 22, wherein said step of approval comprises including at least one of:
reviewing said first modified construction project for accuracy;
inspecting a site for building said first modified construction project;
generating architectural plans for said first modified construction project; and determining whether said estimate for building said first modified construction project indicates a profit margin.

24. The method of claim 22, further comprising executing said contract when, upon completing said approval process, determining that said first modified construction project is profitable.

25. The method of claim 22, wherein retrieving said first electronic construction information is made as a function of price of said first construction information.

26. The method of claim 22, wherein retrieving said second electronic construction information is made as a function of price of said at least one construction feature.

27. The method of claim 22, further comprising determining direct costs and indirect costs related with said first modified construction project.

28. The method of claim 27, wherein said direct costs comprise costs of materials and labor associated with using said materials.

29. The method of claim 27, wherein said indirect costs comprise costs of labor not associated with using said materials.

30. The method of claim 27, wherein said indirect costs include attorney fees, accountant fees, realtor fees and costs of permits.

31. A method for using a database to manage parties to at least one future construction project, said method comprising:
storing builder information representing at least one enforceable builder contract for a builder to provide building services in said at least one future construction project;
storing vendor labor information representing a plurality of enforceable vendor contracts for a plurality of vendors to provide labor in said at least one future construction project;
storing materials supplier information representing a plurality of enforceable contracts for at least one materials supplier to provide materials in said at least one future construction projects; and
storing buyer information representing an enforceable contract for at least one buyer to purchase a first future construction project.

32. A method for using a user terminal coupled to a site processor across a communication network to manage new constructions, said method comprising:
selecting from a database electronic standard construction information including characteristics related to at least one of total square footage, garage size, number of rooms, number of bathrooms, location of rooms, and price;
selecting from said database electronic modification information including characteristics related to at least one of construction features;
using an algorithm that applies said electronic modification information to said electronic standard construction information and generates electronic modified construction information;
using an algorithm that retrieves from said database electronic labor information including characteristics related to at least one of builders, sub-contractors, vendors, materials suppliers, time estimates, and cost estimates related to at least one materials and labor.

33. The method of claim 32, further comprising using said algorithm to electronically schedule at least one task associated with building a construction represented by said modified construction information.

34. The method of claim 33, further comprising using said algorithm to electronically notify parties contributing labor and transmitting details of said labor to said parties and electronically receiving feedback from said parties contributing said labor substantially automatically.

35. A system for predicting the cost of labor and materials for building a new construction, said system comprising:
a construction module adapted to store electronic construction information including characteristics related to new constructions in a database;
a labor module adapted to store electronic labor information including characteristics related to labor for building said new constructions in said database;
a materials module adapted to store electronic materials information including characteristics related to materials for building said new constructions in said database;
a standard constructions interface adapted to retrieve electronic construction information from said database to represent a new construction;
a construction modification interface, said construction modification interface adapted to retrieve electronic construction information from said database to represented a modification to said new construction;
an output module adapted to determine cost of labor and materials for building said new construction and providing at least one of a predicted image of said new construction and a detailed description of said cost, such that the actual cost of labor and materials after completing said new construction is the same as said predicted cost.
